(19) United States
(12) Patent Application Publication
(10) Pub. No.: US 2025/0038553 A1
(43) Pub. Date: Jan. 30, 2025

(54) WORK AREA CHARGER

(71) Applicant: MILWAUKEE ELECTRIC TOOL CORPORATION, Brookfield, WI (US)

(72) Inventors: Isabel M. Lloyd, West Allis, WI (US); Christopher S. Spaulding, Green Bay, WI (US); Shreyas Sridar, Milwaukee, WI (US); Matthew Post, Milwaukee, WI (US); Colin J. Roberts, Brookfield, WI (US); Matthew N. Thurin, Richfield, WI (US); Jeremy R. Ebner, East Troy, WI (US); Kevin D. White, Milwaukee, WI (US)

(21) Appl. No.: 18/712,410

(22) PCT Filed: Nov. 23, 2022
(86) PCT No.: PCT/US22/50905

§ 371 Date: May 22, 2024

Related U.S. Application Data
(60) Provisional application No. 63/283,128, filed on Nov. 24, 2021.
(60) Provisional application No. 63/342,426, filed on May 16, 2022.
(60) Provisional application No. 63/403,135, filed on Sep. 1, 2022.

(51) Int. Cl. H02J 7/00

(52) U.S. Cl. CPC H02J 7/0045; H02J 7/00032

(57) ABSTRACT

A charging box has a housing with first and second ends, charging bays, a cover, and a lock assembly. The charging bays are between the first end and the second end. Each of the charging bays removably receives a battery pack in an insertion direction. The cover pivots on the housing nearer to the second end than to the first end. The cover moves between an open position and a closed position. The lock assembly includes a staple, a slot in the cover, a protrusion coupled to the housing adjacent the staple, and a tether coupled to the housing. The staple is nearer to the first end than to the second end. The staple receives a padlock. The slot receives the staple therethrough. The tether has a distal end with a loop. The loop is receivable about the protrusion.

### CROSS-REFERENCE TO RELATED APPLICATIONS

This application claims priority to prior-filed, co-pending U.S. Provisional Patent Application No. 63/283,128, filed on Nov. 24, 2021, U.S. Provisional Patent Application No. 63/342,426 filed on May 16, 2022, and U.S. Provisional Patent Application No. 63/403,135, filed on Sep. 1, 2022, the entire contents of which are incorporated herein by reference.

### FIELD

The present disclosure relates to a battery charger. More particularly, the present disclosure relates to a portable battery charger that is adapted to receive multiple power tool battery packs.

### BACKGROUND

Worksites can be very expansive, and many times workers have to change locations and need to carry all of their equipment (e.g., chargers, tools, etc.) with them. Therefore, it is beneficial for work area charges to be compact, light, and to have one or more handles so that a worker can easily transport the charger from one location to another.

Many worksites can be in locations that are prone to harsh environmental impacts that may be damaging to electrical devices. The chargers may be susceptible to damage from cold temperatures, rain, and spills. It can be beneficial to create a charger that has active or passive environmental protection, so that the charger can be used in a variety of locations.

Since battery packs are expensive and chargers are often left unattended, it may be beneficial to have a lock assembly in place that locks either the entire charger or the individual battery packs in the charging docks.

Some embodiments of the present disclosure take these three desired features into account and balance them. Since increased security and environmental protection often means increased weight and size, one or more arrangements and forms of a charger is sought herein to provide an optimization of portability, environmental protection, and security.

### SUMMARY

The invention provides, in one aspect, a charging box having a housing with a first end and a second end, a plurality of charging bays, a cover, and a lock assembly. The plurality of charging bays are disposed between the first end and the second end. Each of the plurality of charging bays are configured to removably receive a battery pack in an insertion direction. The cover is pivotably coupled to the housing nearer to the second end than to the first end. The cover is moveable between an open position and a closed position. The lock assembly includes a staple, a slot defined in the cover, a protrusion coupled to the housing adjacent the staple, and a tether coupled to the housing. The staple is coupled to the housing nearer to the first end than to the second end. The staple is configured to receive a padlock. The slot is configured to receive the staple therethrough. The tether has a distal end with a loop. The loop is receivable about the protrusion.

The invention provides, in another aspect, a charging box having a housing having a first end and a second end opposite the first end, a plurality of charging bays disposed between the first end and the second end, a bar pivotably coupled to the housing nearer to the second end than to the first end, and a lock assembly. Each of the plurality of charging bays is configured to removably receive a battery pack. The bar is moveable between an open position and a closed position. The bar overlaps each of the plurality of charging bays in the closed position. The lock assembly includes a pair of staples forming a receiving space therebetween, a protrusion coupled to the housing adjacent the pair of staples, and a tether coupled to the housing. The bar occupies the receiving space with the bar in the closed position. The tether has a distal end having a loop. The loop is receivable about the protrusion.

The invention provides, in another aspect, a charging box having a housing comprising a first end and a second end opposite the first end, a plurality of charging bays disposed between the first end and the second end, a plurality of tabs moveably coupled to the housing, an actuator configured to move the plurality of tabs, and a staple coupled to the housing. Each of the plurality of charging bays is configured to removably receive a battery pack in an insertion direction. Each of the plurality of tabs is moveable between an extended position and a retracted position. Each of the plurality of tabs is configured to cover at least a portion of a battery pack received in the plurality of charging bays with the plurality of tabs in the extended position. The actuator is configured to move the plurality of tabs between the extended position and the retracted position. The actuator has a slot through hole. The staple has a staple through hole. The staple through hole is configured to algin with the actuator through hole with the plurality of tabs in the extended position.

The invention provides, in yet another aspect, a charging box having a housing defining a cavity therein, a cover coupled to the housing, a plurality of charging bays disposed in the cavity, a hook coupled to the housing, and a tether having a distal end. The housing has a through hole. The cover is pivotable between an open position and a closed position. The cover and the housing enclose the cavity with the cover in the closed position. The cover has a cover through hole. The cover through hole is configured to align with the through hole with the cover in the closed position. Each of the plurality of charging bays is configured to receive a battery pack. The hook and the cover configured to form a closed loop with the cover in the closed position. The distal end of the tether is removably coupled to the hook. The distal end is trapped onto the hook with the cover in the closed position. The through hole and the cover through hole are configured to receive a padlock with the cover in the closed position.

The invention provides, in still another aspect, a charging box having a housing defining a handle and a base opposite the handle, a plurality of charging bays disposed between the base and the handle, a controller disposed in the housing, and a wireless communication device configured to receive signals from the controller. Each of the plurality of charging bays are configured to receive a battery pack. The wireless communication device is operable to transmit signals to a remote device. The signals corresponds to information about at least one of the following: a location of the charging box, a charging speed of at least one of the plurality of charging bays, a power level of the charging box, a charge status of a battery pack received by one of the plurality of charging bays, the health of the charging box, the health of a battery pack received in one of the plurality of charging bays.

### BRIEF DESCRIPTION OF THE DRAWINGS

FIG. 1 is a perspective a portable charger, according to embodiments disclosed herein.

FIG. 2 is a perspective view of the portable charger of FIG. 1, including a cover.

FIG. 3 is a top view of the portable charger of FIG. 2.

FIG. 4 is a front view of the portable charger of FIG. 3.

FIG. 5 is a side view of the portable charger of FIG. 4.

FIG. 6 is a perspective view of the portable charger of FIG. 2.

FIG. 7 is another perspective view of the portable charger of FIG. 2.

FIG. 8 is a perspective view of the portable charger of FIG. 2, including a locking mechanism.

FIG. 9 is a side view of the portable charger of FIG. 2 being tethered.

FIGS. 10A-10B are detailed views of a locking mechanism of the portable charger of FIG. 2.

FIG. 11 is a side view of the portable charger of FIG. 2 being carried.

FIG. 12 is a side view of the portable charger of FIG. 2.

FIG. 13 is a perspective view of another portable charger, according to embodiments disclosed herein.

FIG. 14 is a top view of the portable charger of FIG. 13.

FIG. 15 is a bottom view of the portable charger of FIG. 13

FIG. 16 is a front view of the portable charger of FIG. 13.

FIG. 17 is a cross-section view of the portable charger of FIG. 13.

FIG. 18 is a perspective view of yet another portable charger, according to embodiments disclosed herein.

FIG. 19 is a detailed view of the battery lock mechanism of the portable charger of FIG. 18.

FIG. 20A is a top view of the portable charger of FIG. 18 in the unlocked position.

FIG. 20B is a top view of the portable charger of FIG. 18 in the locked position.

FIG. 21 is a perspective view of still another portable charger, according to embodiments disclosed herein.

FIG. 22 is a top view of the portable charger of FIG. 21.

FIG. 23 is a bottom perspective view of the portable charger of FIG. 21.

FIG. 24 is a perspective view of the portable charger of FIG. 21 with a rain cover.

FIG. 25 is a perspective view of another portable charger, according to embodiments disclosed herein.

FIG. 26 is a perspective view of the portable charger of FIG. 25 with the cover removed.

FIG. 27 is a front view of the portable charger of FIG. 25.

FIG. 28 is bottom view of the portable charger of FIG. 25.

FIG. 29A is a perspective view of yet another portable charger, according to embodiments disclosed herein, with the portable charger in the unlocked position.

FIG. 29B is a perspective view of the portable charger of FIG. 29A, with the potable charger in the locked position.

FIG. 30 is a perspective view of still another portable charger, according to embodiments disclosed herein.

FIG. 31 is another perspective view of the portable charger of FIG. 30.

FIG. 32 is a side view of the portable charger of FIG. 30.

FIG. 33 is a front view of the portable charger of FIG. 30.

FIG. 34 is a bottom view of the portable charger of FIG. 30, with mounting cleats.

FIG. 35A-35B are detailed views of the locking mechanism of the portable charger of FIG. 30.

FIG. 36 is a perspective view of yet another portable charger, according to embodiments disclosed herein.

FIG. 37 is a side view of the portable charger of FIG. 36.

FIG. 38 is another perspective view of the portable charger of FIG. 36.

FIGS. 39A-39B are perspective views of the portable charger of FIG. 36 in the locked and the unlocked position.

FIG. 40 is a perspective view of still another portable charger, according to embodiments disclosed herein.

FIG. 41 is another perspective view of the portable charger of FIG. 40 with the battery packs removed.

FIG. 42 is a front view of the portable charger of FIG. 41.

FIG. 43 is a top view of the portable charger of FIG. 41.

FIGS. 44A-44D are example screen views of a remote device.

Features and aspects of the disclosure will become apparent by consideration of the following detailed description and accompanying drawings.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting.

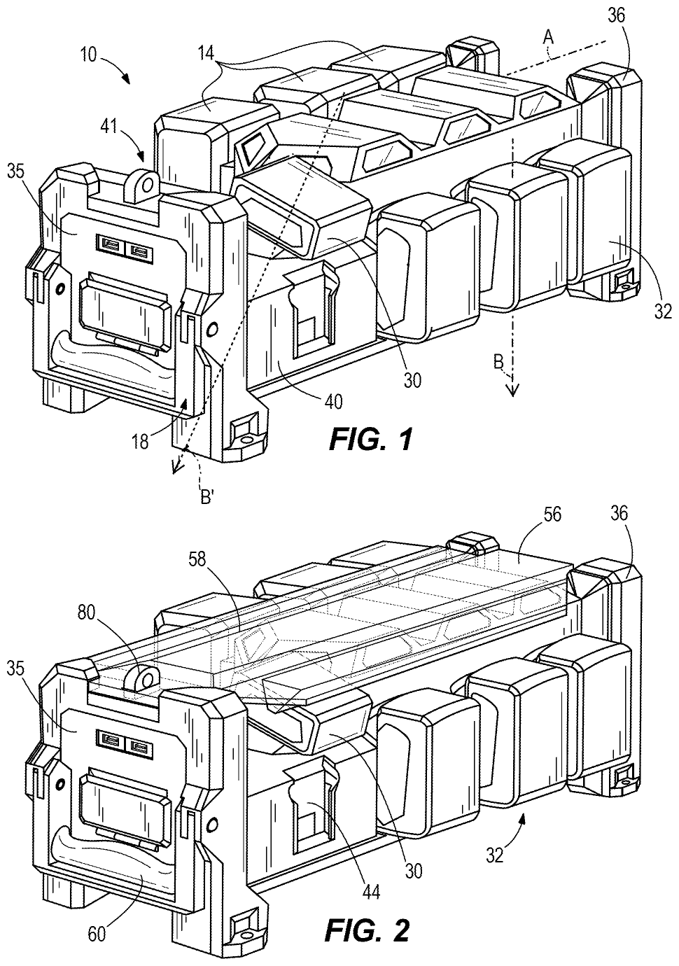

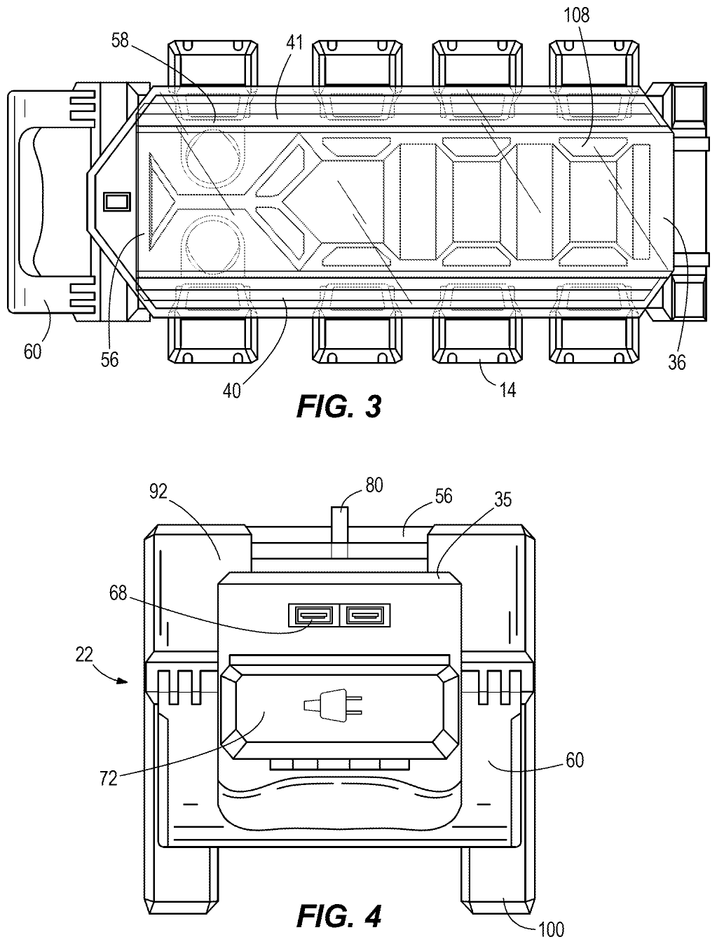

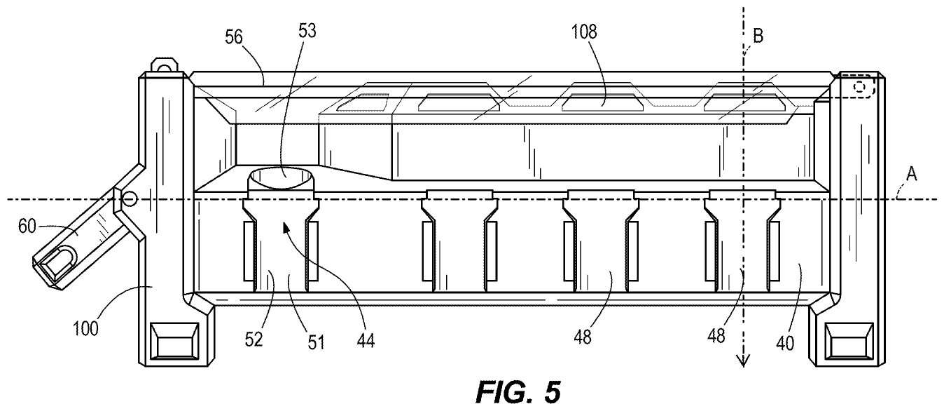

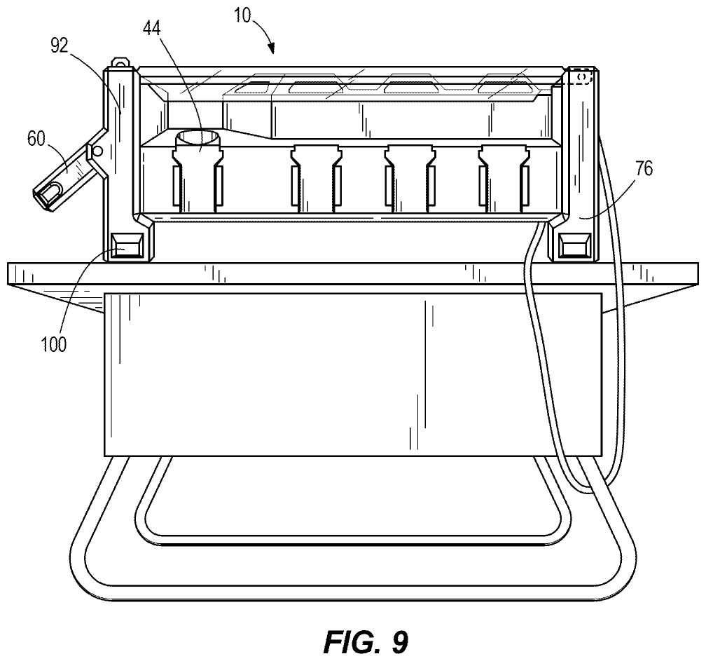

With reference to FIGS. 1-12, a first embodiment of a portable charger 10 is shown. The portable charger 10 is operable to charge multiple battery packs 14. The portable charger 10 includes a housing 18, a power assembly 22, and a lock assembly 26. The portable charger 10 can be placed on a work surface and can be carried by a worker.

The housing 18 has a generally rectangular shape. The housing 18 defines a first end 35, a second end 36 opposite the first end 35, a first side 40, and a second side 41 opposite the first side 40. The first side 40 and the second side 41 are elongated and extend along an axis A. The housing 18 may have an I-beam shape, wherein the two ends 35, 36 extend past the sides 40, 41 in at least two directions. Said another way, the ends 35, 36 are wider and taller than the two elongated sides 40, 41.

The two elongated sides 40, 41 include a plurality of battery receiving portions 44 (e.g., a plurality of charging bays) such that the plurality of battery receiving portions 44 is between the first end 35 and the second end 36. In the illustrated embodiment, the charger 10 includes eight battery receiving portions 44. More specifically, the charger 10 includes four battery receiving portions 44 on the first side 40 and four battery receiving portions 44 on the second side 41. The battery receiving portions 44 physically secure the battery packs 14 to the charger 10 and electrically connect the battery packs 14 to the charger 10. The battery receiving portions 44 include an electrical interface that is connectable to a battery interface on the battery packs 14 such that the battery packs 14 are in electrical communication with the battery receiving portions 44. The charger 10 can supply power to the battery packs 14 via the battery receiving portions 44. In some embodiments, the charger 10 is configured to charge multiple battery packs 14 simultaneously. In the illustrated embodiment, the charger 10 can charge four battery packs 14 simultaneously. In other embodiments, the charger 10 is configured to charge five, six, seven, or all eight of the battery packs 14 simultaneously.

The charger 10 is operable to charge multiple battery packs 14, and more specifically, the charger 10 is operable to charge a first type of battery pack 30 and a second type of battery pack 32. In the illustrated embodiment, the first type of battery pack 30 is a 12-Volt battery pack and the second type of battery pack is an 18-Volt battery pack. The battery receiving portions 44 include a plurality of a first type of charging bays 48 (e.g., a first subset) and a plurality of a second type of charging bays 52 (e.g., a second subset).

The first type of charging bay 48 may be configured to only receive the first type of battery pack 30. The first type of charging bay 48 may be disposed on the sides 40, 41 such that the first type of battery pack 30 is insertable in an insertion direction B. More specifically, the insertion direction B may be in the downward direction toward the worksurface such that the insertion direction B is transverse to the axis A. In the illustrated embodiment, the charger 10 has six charging bays of the first type 48. In other embodiments, the charger 10 may have more or less of the first type of charging bays.

The second type of charging bay 52 may be configured to receive the first type of battery pack 30, the second type of battery pack 32, or the first type and second type of battery pack 30, 32. The second type of charging bay 52 includes a first electrical interface 51 that is configured to connect with the first type of battery pack 30 and a second electrical interface 53 that is configured to connect with the second type of battery pack 32. The first electrical interface 51 may be disposed on the sides 40, 41 such that the first type of battery pack 30 is insertable in the insertion direction B. The second electrical interface 53 may be spaced from the first electrical interface 51. In the illustrated embodiment, the second electrical interface 53 is disposed at an angle relative to the work surface such that the second type of battery pack 32 is insertable in the insertion direction B′. The insertion direction B′ is transverse to the axis A. More specifically, the angle between the insertion direction B′ and the axis A is between 10 degrees and 50 degrees. In the illustrated embodiment, the angle is around 30 degrees. In other embodiments, the second electrical interface 53 may be spaced from the first electrical interface 51 such that the second type of charging bay 52 can receive the first type of battery pack 30 and the second type of battery pack 32 simultaneously. In the illustrated embodiment, the charger 10 has two charging bays of the second type 52. In other embodiments, the charger 10 may have more or less of the second type of charging bays 52.

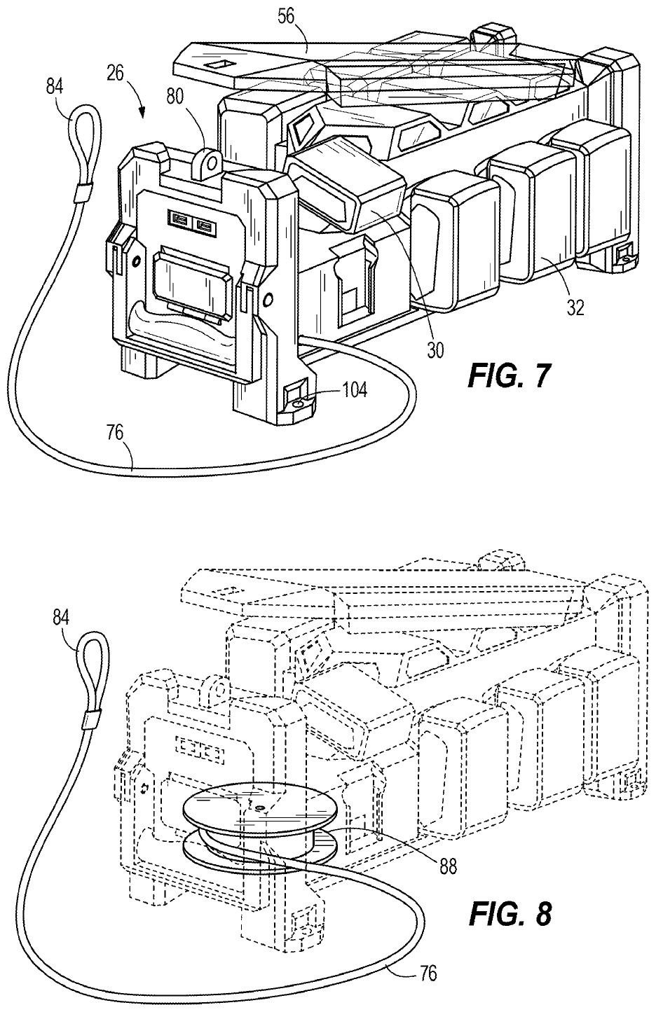

With reference to FIG. 2, a cover 56 maybe coupled to the housing 18. The cover 56 is pivotably coupled to the housing nearer to the second end 36 than to the first end 35. More specifically, the cover 56 is coupled to the housing 18 adjacent the second end 36. The cover 56 can pivot between an open position (e.g., FIG. 7) and a closed position (e.g., FIG. 2). In the closed position, the cover 56 at least partially covers and protect the charger 10 from fluid ingress and exposure to the environment (e.g., rain, water leaks). In the closed position, the cover 56 may cover a majority of the battery receiving portion 44 when viewed along the insertion direction B. More specifically the cover 56 may extend along the axis A and extend perpendicular to the axis A such that the cover 56 extends past the battery packs 14 and the battery receiving portions 44 to cover and protect the battery packs 14 and the battery receiving portions 44 from fluid ingress and exposure to the environment. In other embodiments, the cover 56 may be a removeable cover that can be completely removed from the charger 10.

The cover 56 may be made from a clear material (e.g., clear polycarbonate) such that the battery packs 14 and the battery receiving portions 44 are visible when the cover 56 is in the closed position. The clear material allows there to be a visual inventory of the battery packs 14 allowing the worker to know the number of battery packs 14 that are connected to the charger 10 when the cover 56 is in the closed position.

The cover 56 may include a steel reinforcement bar 58. The steel reinforcement bar 58 may extend along the perimeter of the cover 56. The steel reinforcement bar 58 supports the cover 56 and prevents the cover 56 from deformation.

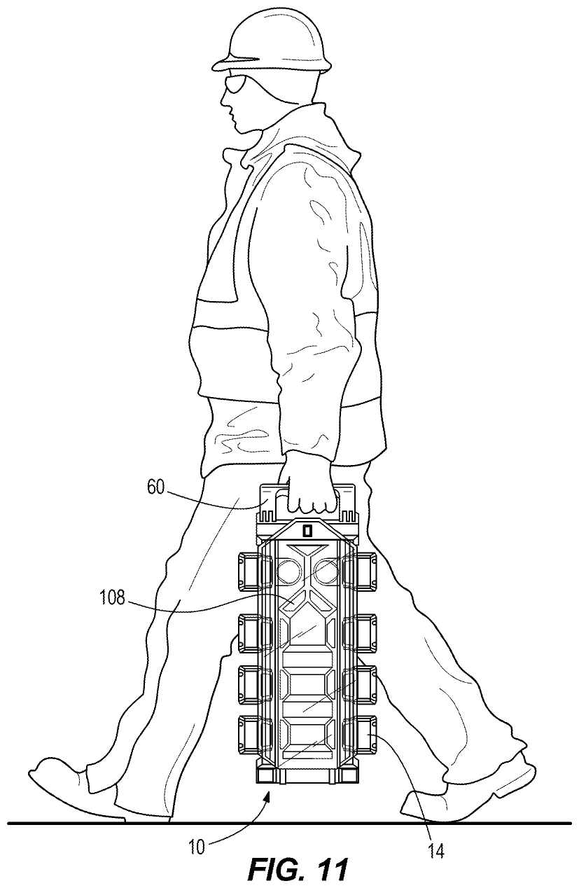

The housing 18 may further include a carry handle 60. The carry handle 60 may be located on one of the two ends 35, 36. In the illustrated embodiment, the carry handle 60 is disposed on first end 35 of the housing 18. The first end 35 may include a recess sized to fit the carry handle 60. The carry handle 60 may be pivotable between a rest position and an extended position. In the rest position, the carry handle 60 is disposed in the recess (FIG. 2). In the extended position, the carry handle 60 is extended from the charger 10 such that the worker can grasp the carry handle 60 and carry the charger 10 (FIG. 11). In other embodiments, the charger 10 may have a carry handle 60 located on both of the two ends 35, 36 of the charger 10. In other embodiments, the carry handle 60 may be a rigid carry handle that is fixed in the extended state.

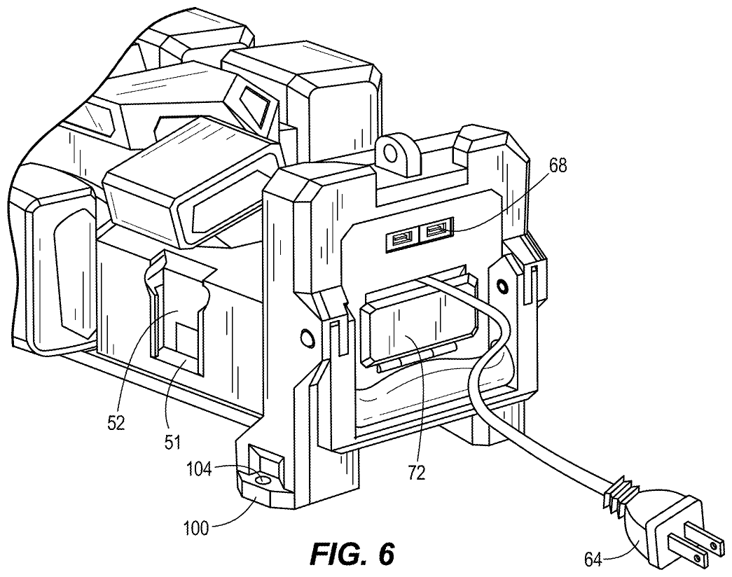

With reference to FIGS. 4 and 6, the power assembly 22 is located on the first end 35 of the charger 10. The power assembly 22 includes a plug attached to a power cord 64 and includes at least one outlet port 68. The power cord 64 may be adapted to receive a power supply from a power source (e.g., receive 110V AC from mains electricity) in order to supply power to the charger 10. The supplied power may be used to directly charge the connected battery packs 14. The supplied power may also be used to charge an internal battery (not shown). The internal battery allows the charger 10 to be used (i.e., charge the battery packs 14) in a remote location when there are no power sources.

The charger 10 may include a cord management system 72 that is configured to store and organize the power cord 64 when the power cord 64 is not in use. The cord management system 72 may be a pocket disposed the first end 35 of the charger 10. The cord management system 72 may include a cover that protects the power cord 64 from dust and water. The inside of the cord management system 72 may include a set of arms or extensions around which the cord of the power cord 64 can be wrapped.

The outlet port 68 allows the user to plug in other devices, such as a cell phone or a tablet to be charged by the charger 10. The outlet port 68 may be a USB port. The outlet port 68 may be covered with a panel to protect the outlet port 68 from water damage. In the illustrated embodiment, the charger 10 includes two outlet ports 68 that are USB ports. In other embodiments, the charger 10 may include additional or fewer outlet ports. In other embodiments, the charger 10 may also include an outlet port that is a 110-Volt AC port.

With reference to FIGS. 7-10B, the lock assembly 26 is configured to protect the entire charger 10 from theft and protect the individual battery packs 14 from being removed from the charger 10. The lock assembly 26 includes a cable 76 (e.g., a tether) retractably coupled to the housing 18, a padlock latch 80 (e.g., a staple), and a protrusion 90. The lock assembly 26 is configured to secure the charging box 10 to a stable structure (e.g., an anchor point).

The cable 76 may be formed from a coated braided steel cable. The cable 76 includes a distal end 84 and a proximal end that is secured in housing the charger 10 via a reel 88 (e.g., a spool). The distal end 84 may end in a loop. The reel 88 is disposed inside the charger 10 and is configured to store the cable 76 when the cable 76 is not in use. The cable 76 may be wrapped around the reel 88. The reel 88 also allows the cable 76 to be easily retracted from the charger 10. The reel 88 may be a manual reel or a retracting reel. The reel 88 may include a hand crank reel to retract the cable 76 from the housing or a spring-loaded reel to retract the cable 76 from the housing. In the illustrated embodiment, the cable 76 is six feet long and has a quarter inch diameter. In other embodiments, a thinner, wider, longer, or shorter cable can be used.

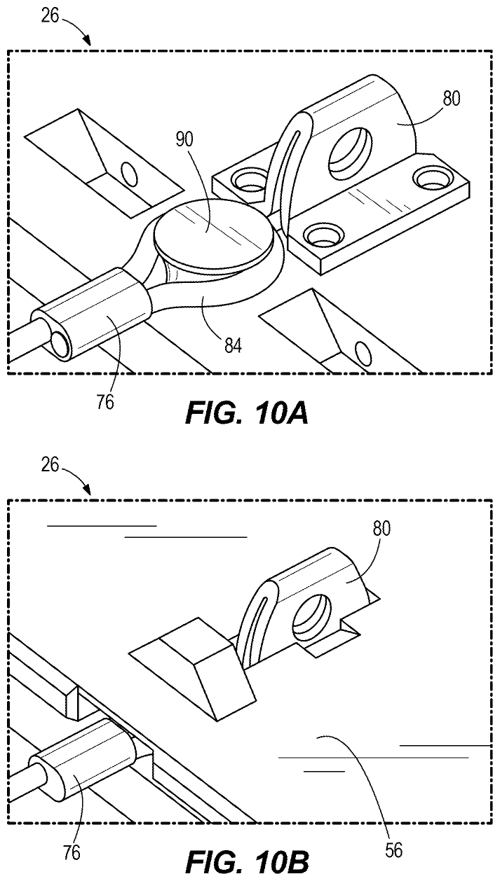

With particular reference to FIGS. 10A and 10B, the padlock latch 80 is coupled to the housing 18 nearer to the first end 35 than to the second end 36. More specifically, the padlock latch 80 is coupled to the housing 18 adjacent the first end 35. The padlock latch 80 includes an opening that is configured to receive a padlock. The cover 56 includes a slot that is configured to receive the padlock latch 80 when the cover 56 is in the closed position. When the padlock is received in the padlock latch 80, the padlock can secure the cover 56 in the closed position.

The protrusion 90 is disposed on the housing 18 adjacent to the padlock latch 80. The protrusion 90 is sized such that the distal end 84 of the cable 76 can be received about (e.g., wrapped around, snapped to, etc.) the protrusion 90. The protrusion 90 and the distal end 84 of the cable 76 are covered by the cover 56 when the cover 56 is in the closed position. When the cover 56 is in the closed position, the distal end 84 of the cable 76 is trapped onto the protrusion 90 such that the cable 76 cannot be unwrapped or removed from the protrusion 90.

In use, the cable 76 is wrapped around the stable structure (e.g., a table, a column) to secure the charger 10 to the structure (shown in FIG. 9). Once the cable 76 is wrapped around the object, the distal end 84 of the cable 76 is secured (e.g., snapped) to the protrusion 90 on the charger 10 (FIG. 10A). To further secure the cable 76 to the charger 10, the cover 56 is moved to the closed position such that the cover 56 covers the protrusion 90 and the distal end 84 of the cable 76 (FIG. 10B). The cover 56 prevents the distal end 84 from disengaging with the protrusion 90. The padlock can be inserted into the padlock latch 80 to lock the cover 56 in the closed position. When the cover 56 is locked in the closed position, the battery packs 14 cannot be removed from the charger 10. If the charger 10 is tethered to an object, the padlock ensures that the charger 10 cannot be moved from the object by securing the cable 76 to the charger 10.

The charger 10 may include a drop protection assembly 92 disposed on the housing 18. The drop protection assembly 92 may include molded edges 96 that surround the perimeter of the housing 18 and extend past the housing 18. The molded edges 96 may be made from a rubber material. The molded edges 96 are configured to absorb any shock and impact in case the charger 10 is dropped or collides with an object. In other embodiments, the drop protection assembly may include a roll cage.

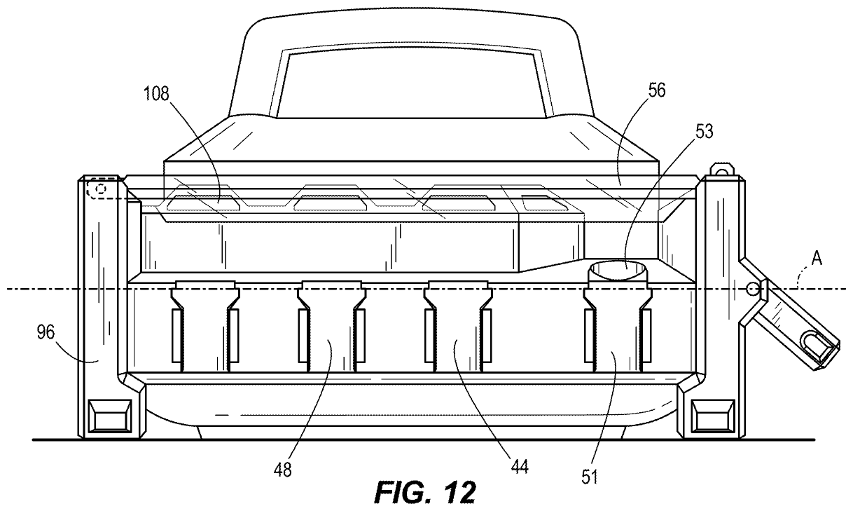

As shown in FIG. 12, the drop protection assembly 92 may further include feet 100 that are made from the same material as the molded edges 96. The feet 100 may extend from the bottom of the housing 18 and lift the charger 10 off the work surface. The feet 100 protect the charger 10 and the battery packs 14 from hazards on the ground (e.g., water). In the illustrated embodiment, the charger 10 has four feet 100, however in other embodiments there may be fewer or additional feet.

The charger 10 may also include mounting tabs 104 (e.g., mounting holes) disposed on the housing 18. The mounting tabs 104 allow the charger 10 to be mounted on a variety of surfaces. The mounting tabs 104 are sized to fit a fastener (e.g., a bolt). In the illustrated embodiment, the mounting tabs 104 are located on the feet 100 of the charger 10. The mounting tabs 104 secure the charger 10 by ensuring that the charger 10 cannot be easily knocked off a surface. The mounting tabs 104 may also allow the charger 10 to be stored vertically.

The charger 10 may also include at least one LED indicator 108. The LED indicator 108 is disposed on the housing 18. The LED indicator 108 may be angled upwards (e.g., at a 45-degree angle) relative to the axis A such that the LED indicator 108 is visible across the worksite. The LED indicator 108 may also visible when the cover 56 is in the closed position. The LED indicator 108 is operable to show the condition of the charger 10 and the battery packs 14. For example, the LED indicator 108 may flash in a unique pattern when the charger 10 is disconnected from the power supply or if the charger 10 has lost power. The LED indicator 108 may be green when the battery packs 14 are completely charged, and the LED indicator 108 may be orange when the battery packs 14 are being charged. In the illustrated embodiment, the charger 10 has a plurality of LED indicators 108, and more specifically, each battery receiving portion 44 has its own LED indicator 108. In other embodiments, the charger 10 may have additional or fewer LED indicators.

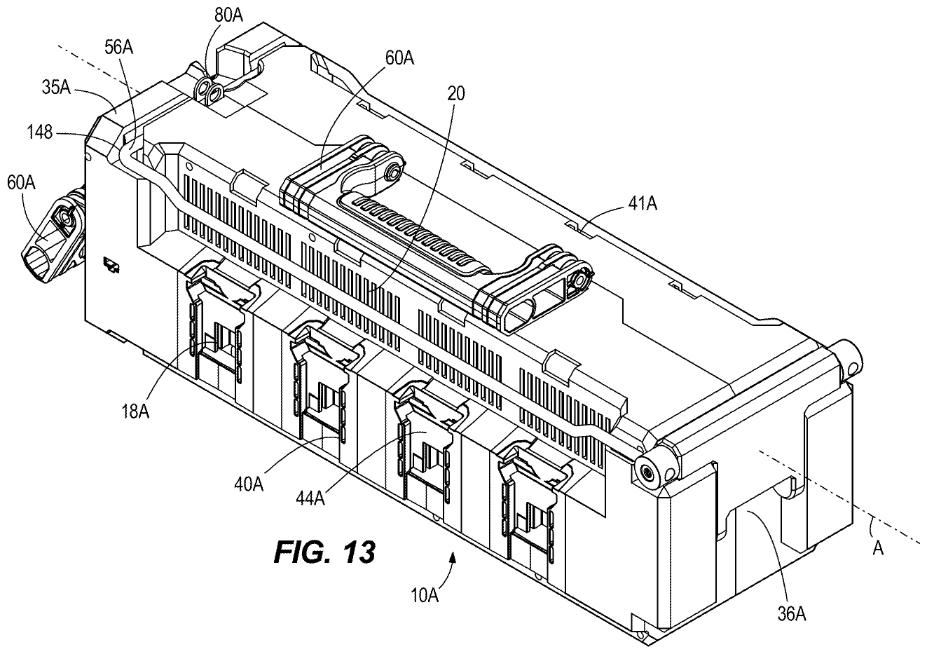

Turning to FIGS. 13-17, another embodiment of a portable charger 10A is shown. Many features of the charger 10A are similar to those discussed above with regard to the charger 10. As such, many of these features will not be discussed again below.

The charger 10A includes a generally rectangular housing 18A, a power assembly 22A, and a lock assembly 26A. The housing 18A defines a first end 35A, a second end 36A opposite the first end 35A, a first side 40A, and a second side 41A opposite the first side 40A. The first side 40A and the second side 41A are elongated and extend along an axis A.

The two elongated sides 40A, 41A include a plurality of battery receiving portions 44A (e.g., charging bays) such that the battery receiving portions 44A are between the first end 35A and the second end 36A. In the illustrated embodiment, the charger 10A includes eight battery receiving portions 44A. More specifically, the charger 10A includes four battery receiving portions 44A on the first side 40A and four battery receiving portions 44A on the second side 41A. In the illustrated embodiment, the charger 10A includes the first type of charging bay and only chargers one type of battery pack. In other embodiments, the charger 10A may include the first type of charging bay and the second type of charging bay such that it can charge multiple types of battery packs.

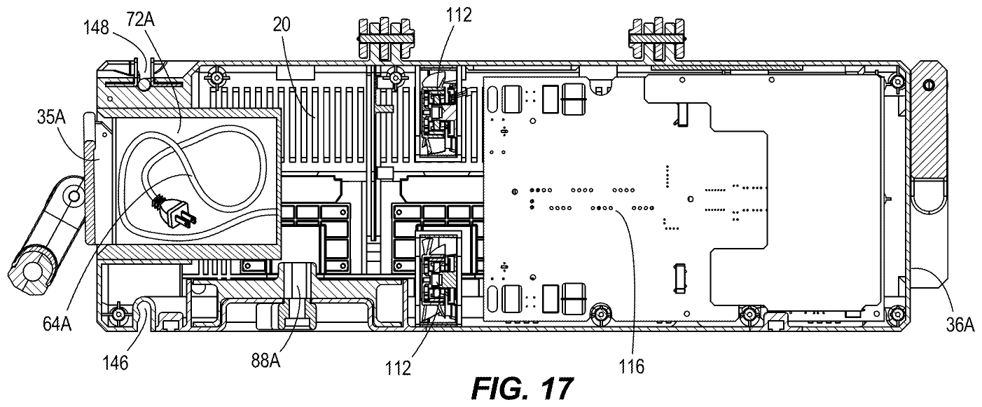

With reference to FIGS. 13 and 17, the housing 18A may include a cover 56A. In the illustrated embodiment, the cover 56A is a steel reinforcement bar that extends along the perimeter of the charger 10A. The cover 56A may be U-shaped and have two legs and a bent section connecting the legs. The cover 56A is pivotably coupled to the second end 36A. The cover 56A can pivot between an open position and a closed position. In the open position, the cover 56A is received in a lower channel 146 that is adjacent the work surface and is disposed on the first end 35A. The lower channel 146 may also extend along the first side 40A and the second side 41B. In the closed position, the cover 56A lies in an upper channel 148 that is opposite the lower channel 146. The upper channel 148 is also disposed on the first end 35A and may extend along the first side 40A and the second side 41A. In the illustrated embodiment, the bent section of the cover 56A is received in the lower channel 146 or the upper channel 148.

When the cover 56A is in the open position, the battery packs 14 can be removed from the charger 10A. When the cover 56A is in the closed position, the cover 56A overlaps the charging bays 44A and prevents the battery packs 14 from being removed from the charger 10A.

The housing 18A may further include a carry handle 60A disposed on the top of the charger 10A (e.g., opposite the work surface) and/or a carry handle 60A disposed on the first end 35A of the charger 10A.

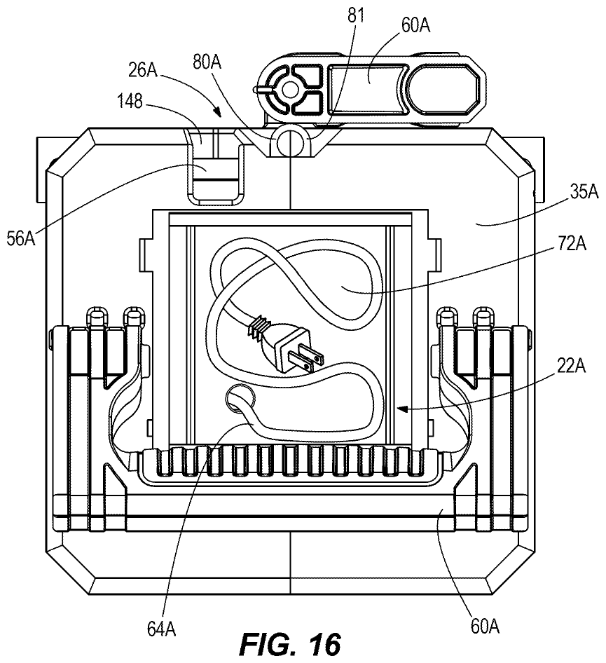

With reference to FIG. 16, the power assembly 22A is located on the first end 35A of the charger 10A. The power assembly 22A may include a plug attached to a power cord 64A. The power cord 64A may be adapted to receive a power supply from a power source (e.g., receive 110V AC from mains electricity) in order to supply power to the charger 10A. The supplied power may be used to directly charge the connected battery packs 14. The supplied power may also be used to charge an internal battery (not shown). The internal battery allows the charger 10A to be used (i.e., charge the battery packs 14) in a remote location when there are no power sources.

The charger 10A may include a cord management system 72A that is configured to store and organize the power cord 64A when the power cord 64A is not in use. The cord management system 72A may be a pocket with a cover disposed the first end 35A of the charger 10A. The inside of the cord management system 72A may include a set of arms or extensions around which the cord of the power cord 64A can be wrapped.

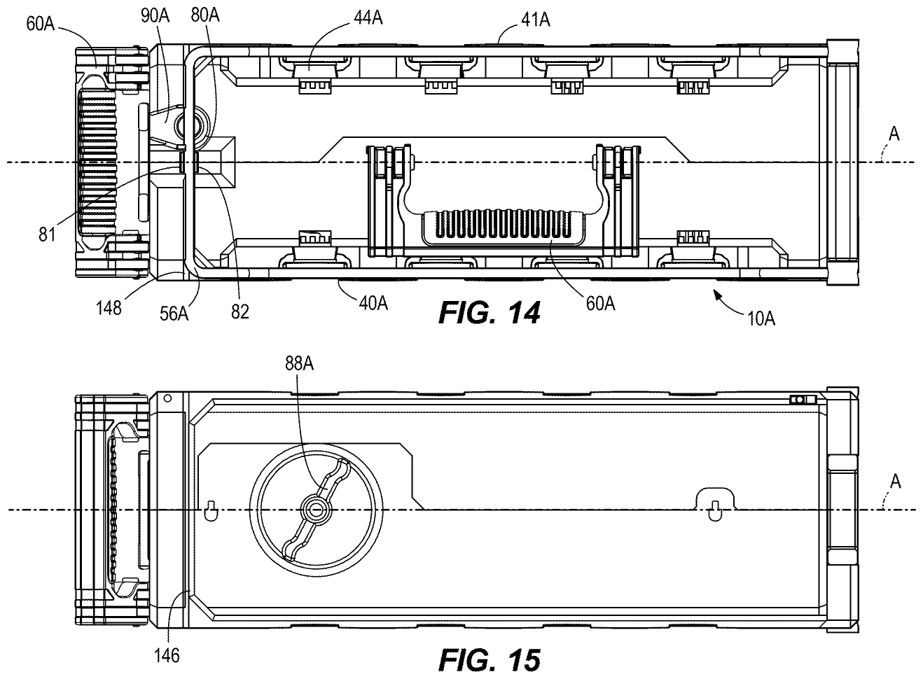

With reference to FIGS. 14 and 16, the lock assembly 26A is configured to protect the entire charger 10A from theft and protect the individual battery packs 14 from being removed from the charger 10A. The lock assembly 26A may include a cable (not shown) secured to a reel 88A, a padlock latch 80A, and a protrusion 90A. The reel 88A is disposed on the bottom of the housing 18A (e.g., adjacent the work surface).

The padlock latch 80A is coupled to the housing nearer to the first end 35A than the second end 36A. More specifically, the padlock latch 80A is coupled to the first end 35A of the housing 18A. The padlock latch 80A is configured to receive a padlock. The padlock latch 80A is comprised of a pair of staples. More specifically, the padlock latch 80A includes a first padlock latch section 81 (e.g., a first staple) and a second padlock latch section 82 (e.g., a second staple). The first padlock latch section 81 and the second padlock latch section 82 form a receiving space therebetween. The receiving space is aligned with the upper channel 148 such that the cover 56A lies in the receiving space when the cover 56A is in the closed position. When the padlock is received in the padlock latch 80A, the padlock secures the cover 56A in the closed position.

The protrusion 90 is disposed on the housing 18A adjacent to the padlock latch 80A. The protrusion 90A is sized such that the distal end of the cable can be received by the protrusion 90A, wrapped around the protrusion 90A, or be snapped around the protrusion 90A. The protrusion 90A and the distal end of the cable are covered by the cover 56A when the cover 56A is in the closed position. When the cover 56A is in the closed position, the cover 56A extends over the protrusion 90A such that the distal end of the cable is secured (e.g., trapped) onto the protrusion 90A such that the cable cannot be unwrapped or removed from the protrusion 90A.

With reference to FIG. 17, the charger 10A includes at least one fan 112 and a controller 116 disposed inside the housing 18A. The fan 112 is configured to cool the charger 10A if the charger 10A becomes overheated. The fan 112 may also cool the battery packs 14 via a plurality of vents 20 that are disposed on the housing 18A. The vents 20 may be configured to direct cool air from the fan 112 to the battery packs 14. In the illustrated embodiment, the charger 10A includes one fan 112 disposed on near the top of the charger 10A and one fan disposed near the bottom of the charger 10A.

The controller 116 is operable to control the charger 10A. For example, the controller 116 may be operable to change the charge speed of the battery packs 14. The controller 116 may also be operable to determine the charge order of the battery packs 14. Additionally, the controller 116 may transmit signals to a wireless communicator that communicates with a remote device (e.g., a cell phone or a laptop) such that the user can control the charger 10A from the remote device.

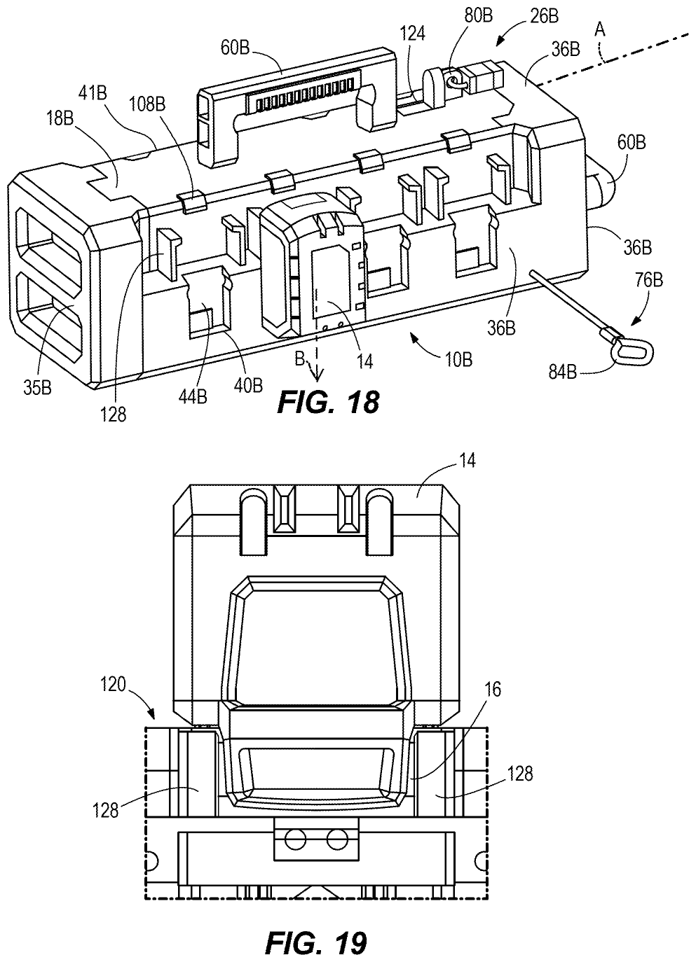

Turning to FIGS. 18-20B, another embodiment of a charger 10B is shown. Many features of the charger 10B are similar to those discussed above with regard to the charger 10. As such, many of these features will not be discussed again below.

The charger 10B includes a housing 18B that has a generally rectangular shape and defines a first end 35B, a second end 36B, a first side 40B, and a second side 41B. The first side 40B and second side 41B extend along an axis A. The charger 10B includes a plurality of battery receiving portions 44B disposed along the first side 40B and the second side 41B such that the battery pack 14 is insertable in an insertion direction B. More specifically, the insertion direction B may be in the downward direction toward the work surface such that the insertion direction B is transverse to the axis A. In the illustrated embodiment, the charger 10B includes eight battery receiving portions 44B.

The housing 18B may include a carry handle 60B disposed on a top surface of the housing 18B and a carry handle 60B disposed on one of the ends 35B, 36B of the housing 18B. The charger 10B includes a lock assembly 26B disposed on one of the two sides 40B of the charger 10B.

The lock assembly 26B has a cable 76B, a battery pack locking mechanism 120, an actuator 124, and a padlock latch 80B. The cable 76B includes a distal end 84B and a proximal end that is retractably coupled to the charger 10B. The cable 76B is configured to be wrapped around a stable structure to secure the charger 10B to the stable structure.

The battery pack locking mechanism 120 is configured to secure the battery packs 14 to the charger 10B. The battery pack locking mechanism 120 includes a plurality of tabs 128 disposed on the battery receiving portions 44B. More superficially, each battery receiving portion 44B includes a tab 128 on either side (e.g., on opposite sides) of the battery receiving portion 44B. In the illustrated embodiment, the plurality of tabs 128 are L-shaped.

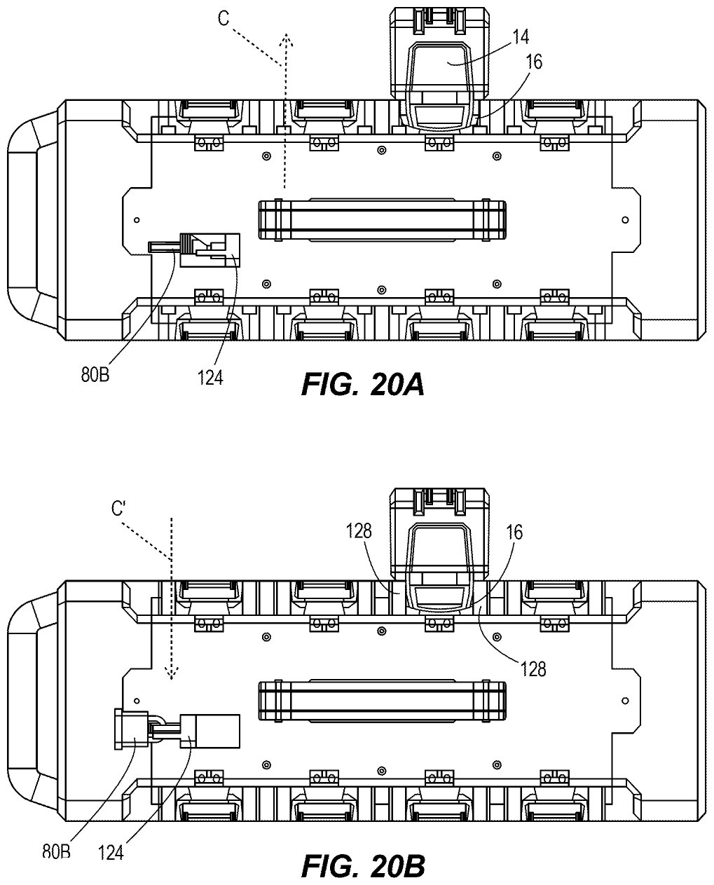

The tabs 128 are moveable between an unlocked position (e.g., a retracted position, FIG. 20A) and a locked position (e.g., an extended position, FIG. 20B). In the unlocked position, the tabs 128 are spaced from the battery packs 14 such that the battery packs 14 can be removed from the charger 10B without interference. In the illustrated embodiment, tabs 128 are at least partially recessed or disposed in the housing 18B when the tabs 128 are in the unlocked position. More specifically, the majority of each of the tabs 128 is recessed in the housing 18B in the unlocked position. In the locked position, the tabs 128 are extended from the housing 18B and cover at least a portion of the battery pack 14 in the receiving portion 44B. More specifically, the tabs 128 block a grip portion 16 (e.g., a user engaging portion) of the battery pack 14 such that the battery pack 14 cannot be removed.

The plurality of tabs 128 move along an axis that is transverse to the axis A. More specifically, the plurality of tabs 128 move along an axis that is perpendicular to the axis A. The plurality of tabs 128 move in an extension direction C to move from the unlocked position to the locked position. In the illustrated embodiment, the extension direction C is in a direction away from the housing 18B. The plurality of tabs 128 move in a retraction direction C′ to move from the locked position to the unlocked position. In the illustrated embodiment, the retraction direction C′ is in a direction toward the housing 18B. The retraction direction C′ is opposite to the extension direction C. The extension and retraction directions C′, C′ may be transverse to the insertion direction B. More specifically, the extension and retraction directions C, C′ may be perpendicular to the insertion direction B. In another embodiment, the tabs 128 may move along an axis that is parallel to the axis A.

The actuator 124 is moveable between a first position (FIG.20A) and a second position (FIG. 20B). The actuator 124 may move along an actuator axis that is transverse to the extension and retraction directions C, C′. More specifically, the actuator 124 may be moveable along an actuator axis that is perpendicular to the extension and retraction directions C, C′ but is parallel to the axis A.

The actuator 124 moves the tabs 128 between the unlocked position and the locked position. The actuator 124 may be configured to move the tabs 128 simultaneously. The actuator 124 includes a through hole that is configured to receive a padlock. In the second position, the through hole of the actuator 124 is aligned with the padlock latch 80B such that a padlock can be inserted into the through hole and the padlock latch 80B to lock the actuator 124 in the second position. In the illustrated embodiment, the actuator 124 is a slide mechanism that slides between the first and second position. In other embodiments, the actuator 124 may be a twist mechanism that can be rotated into the first and the second position.

The charger 10B may also include at least one LED indicator 108B. The LED indicator 108B is disposed on the housing 18. The LED indicator 108B is operable to show the condition of the charger 10B and the battery packs 14. The LED indicator 108B may be operable to show if the battery pack locking mechanism 120 of the charger 10B is in the locked state or if the charger 10B is in the unlocked state.

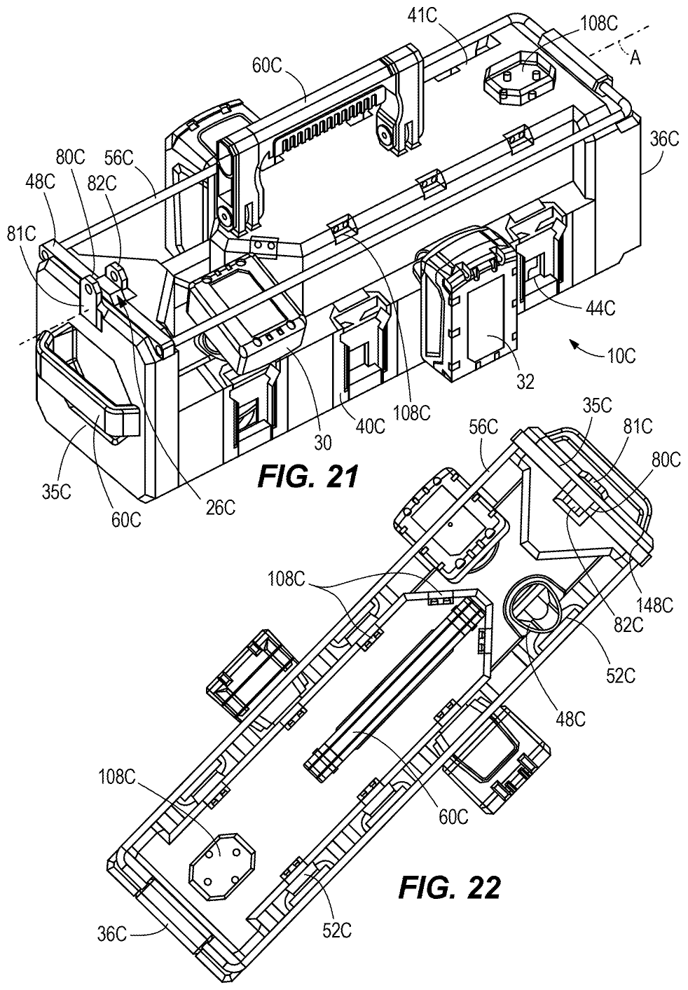

Turning to FIGS. 21-24, another embodiment of a portable charger 10C is shown. Many features of the charger 10C are similar to those discussed above with regard to the charger 10C. As such, many of these features will not be discussed again below.

The charger 10C includes a generally rectangular housing 18C, a power assembly 22C, and a lock assembly 26C. The housing 18C defines a first end 35C, a second end 36C, a first side 40C, and a second side 41C. The first side 40C and the second side 41C are elongated and extend along an axis A.

The two elongated sides 40C, 41C include a plurality of battery receiving portions 44C. In the illustrated embodiment, the charger 10C includes eight battery receiving portions 44C. The charger 10C may include a plurality of a first type of charging bay 48C and a plurality of a second type of charging bays 52C such that the charger 10C is configured to charge multiple types of battery packs 14. In the illustrated embodiment, the charger 10C includes six of the first type of charging bays 48C and two of the second type of charging bay 52C.

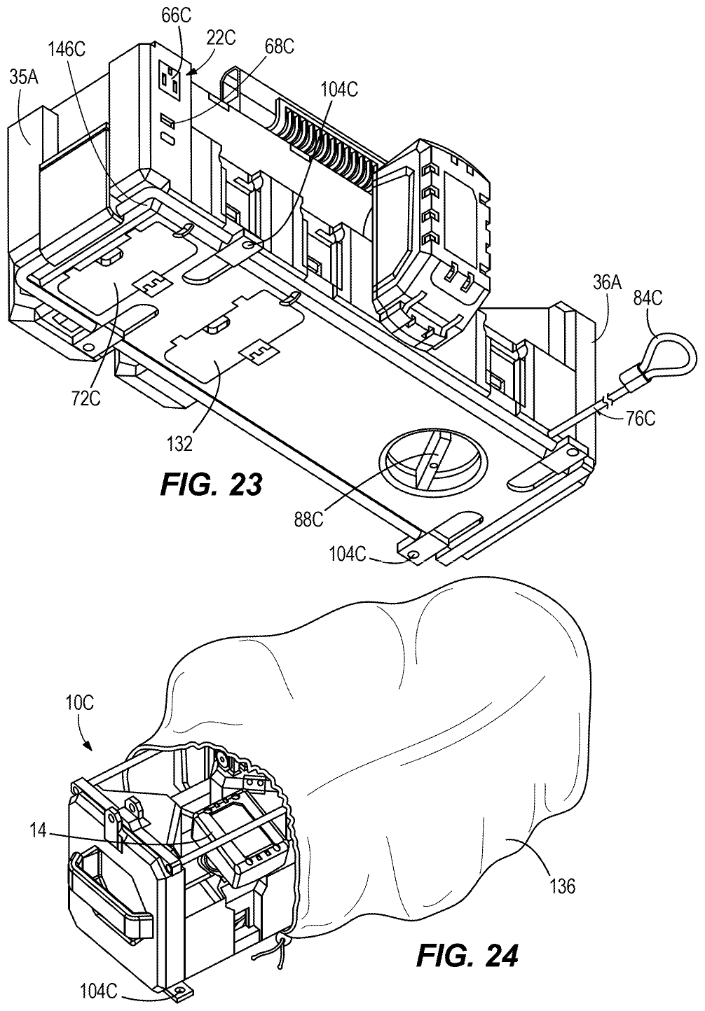

With reference to FIGS. 21 and 23, the housing 18C may include a cover 56C. In the illustrated embodiment, the cover 56C is a steel reinforcement bar that extends along the perimeter of the charger 10C. The cover 56C is pivotably coupled to the second end 36C. The cover 56C can pivot between an open position and a closed position. In the open position, the cover 56C lies in a lower channel 146C that is adjacent the work surface and is disposed on the first end 35C. The lower channel 146C may also extend along the first side 40C and the second side 41C. In the closed position, the cover 56C lies in an upper channel 148C that is opposite the lower channel 146C. The upper channel 148C is also disposed on the first end 35C and may extend along the first side 40C and the second side 41C.

When the cover 56C is in the open position, the battery packs 14 can be removed from the charger 10C. When the cover 56C is in the closed position, the cover 56C covers the battery receiving portions 44C and prevents the battery packs 14 from being removed from the charger 10C.

The housing 18C may further include a carry handle 60C disposed on the top of the charger 10C (e.g., opposite the work surface) and/or a carry handle 60C disposed on the second end 36C of the charger 10C.

With reference to FIG. 23, the power assembly 22C is located on the first or second side 40C, 41C adjacent the first end 35C of the charger 10C. The power assembly 22C may include a plug attached to a power cord. The power cord may be adapted to receive a power supply from a power source (e.g., receive 110V AC from mains electricity) in order to supply power to the charger 10C. The supplied power may be used to directly charge the connected battery packs 14. The supplied power may also be used to charge an internal battery (not shown). The internal battery allows the charger 10C to be used (i.e., charge the battery packs 14) in a remote location when there are no power sources.

The charger 10A may include a cord management system 72C that is configured to store and organize the power cord when the power cord is not in use. The cord management system 72C may be a pocket with a cover disposed the first end 35C of the charger 10C. In the illustrated embodiment, the cord management system 72C is disposed on the bottom of the charger 10C adjacent the work surface.

The outlet port 68C allows the user to plug in other devices, such as a cell phone or a tablet to be charged by the charger 10C. The outlet port 68C may be a USB port. The outlet port 68C may be covered with a panel to protect the outlet port 68C from water damage. In the illustrated embodiment, the charger 10C includes two outlet ports 68C that are USB ports. The charger 10C may also include an outlet port that is a 110-Volt AC port 66C.

With reference to FIGS. 21 and 23, the lock assembly 26C is configured to protect the entire charger 10C from theft and protect the individual battery packs 14 from being removed from the charger 10C. The lock assembly 26C includes a cable 76C and a padlock latch 80C. The cable 76C includes a looped distal end 84C and a proximal end that is secured to the charger 10C via a reel 88C. The reel 88C is disposed inside the charger 10C and is configured to store the cable 76C when the cable 76C is not in use. The reel 88C also allows the cable 76C to be retracted from the charger 10C.

The padlock latch 80C is disposed on the first end 35C of the housing 18C. The padlock latch 80C is configured to receive a padlock. The padlock latch 80C includes a first padlock latch section 81C and a second padlock latch section 82C. The first padlock latch section 81C and the second padlock latch section 82C are separated by the upper channel 148C and form a receiving space. The receiving space is aligned with the upper channel 148C such that the cover 56C lies in the receiving space when the cover 56C is in the closed position. When the padlock is received in the padlock latch 80C, the padlock can secure the cover 56C in the closed position.

The charger 10C may also include mounting tabs 104C (e.g., mounting holes) disposed on the housing 18C. The mounting tabs 104 allow the charger 10C to be mounted on a variety of surfaces. The mounting tabs 104C are sized to fit a fastener (e.g., a bolt). In the illustrated embodiment, the mounting tabs 104C are disposed on the bottom of the charger (e.g., adjacent the work surface).

The charger 10C may also include at least one LED indicator 108C. The LED indicator 108C is disposed on the housing 18C. The LED indicator 108C is operable to show the condition of the charger 10C and the battery packs 14. For example, the LED indicator 108C may flash in a unique pattern when the charger 10C is disconnected from the power supply, if the charger 10C has lost power, or if the charger 10C has low battery. In the illustrated embodiment, the charger 10 has a plurality of LED indicators 108C, and more specifically, each battery receiving portion 44C has its own LED indicator 108C that is operable to show that charge status of the battery pack 14.

With reference to FIG. 24, the charger 10C may include an integrated ingress protection cover 136. Specifically, the cover 136 is composed of a waterproof poncho material and is shaped and sized to wrap around the portable charger 10C. The edge of the cover 136 is sinched and includes a strap, such that a user can tighten the cover 136 around the portable charger 10C. In such embodiments, the bottom surface of the portable charger 10C includes a storage compartment 132 shaped and sized to hold the cover 136.

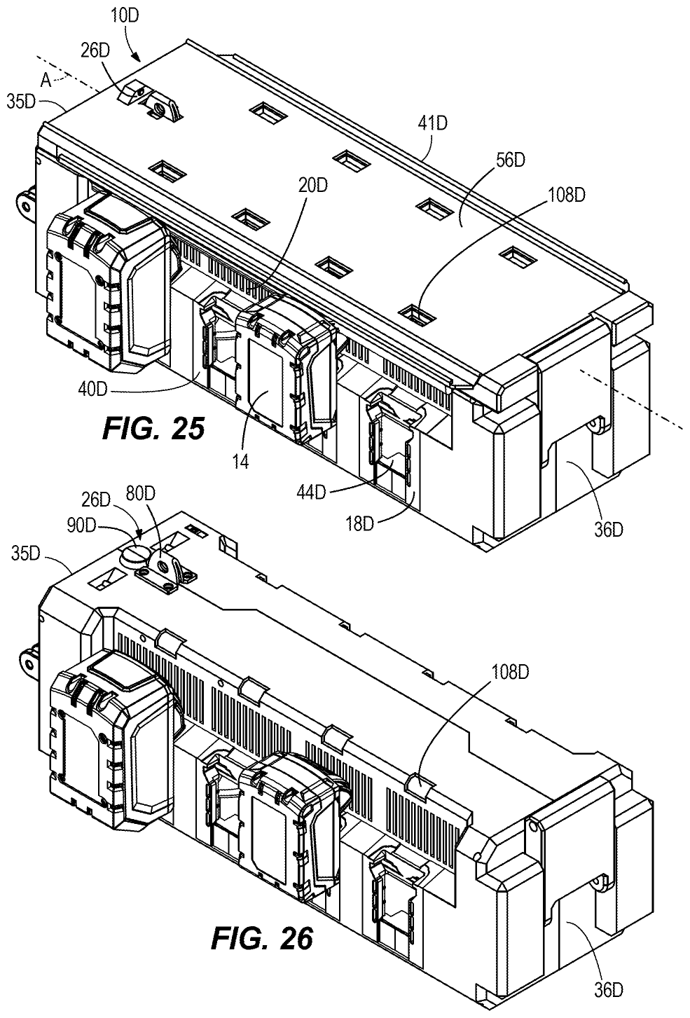

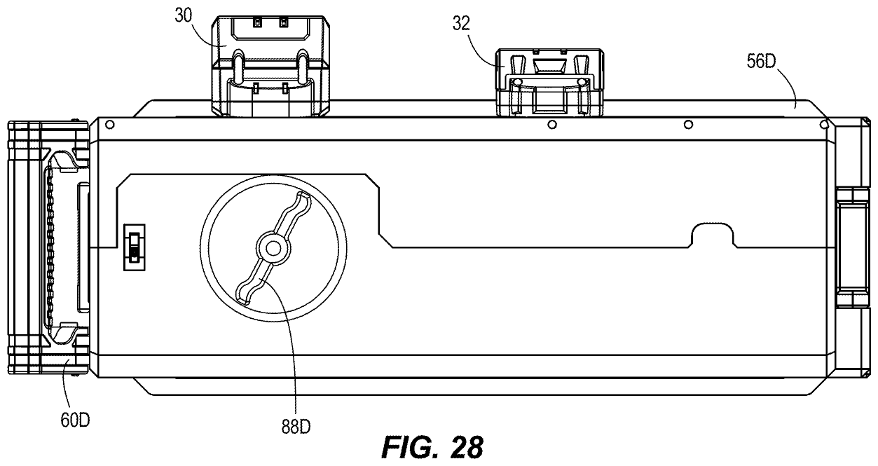

Turning to FIGS. 25-28, still another embodiment of a portable charger 10D is shown. Many features of the charger 10D are similar to those discussed above with regard to the charger 10. As such, many of these features will not be discussed again below.

The charger 10D includes a generally rectangular housing 18D, a power assembly 22D, and a lock assembly 26D. The housing 18D defines a first end 35D, a second end 36D opposite the first end 35D, a first side 40D, and a second side 41D opposite the first side 40D. The first side 40D and the second side 41D are elongated and extend along an axis A. The housing 18D may also define a plurality of vents 20D configured to cool the charger 10D and/or the battery packs 14.

The two elongated sides 40D, 41D include a plurality of battery receiving portions 44D. In the illustrated embodiment, the charger 10D includes eight battery receiving portions 44D. More specifically, the charger 10D includes four battery receiving portions 44D on the first side 40D and four battery receiving portions 44D on the second side 41D. In the illustrated embodiment, the charger 10D includes the first type of charging bay and only charges one type of battery pack. In other embodiments, the charger 10D may include the first type of charging bay and the second type of charging bay such that it can charge multiple types of battery packs.

With reference to FIG. 2, the housing 18D may include a cover 56D. The cover 56D is pivotably coupled to one of the two ends 35D, 36D. In the illustrated embodiment, the cover is coupled to the second end 36D. The cover 56D can pivot between an open position and a closed position (e.g., FIG. 25). The cover 56D may extend along the axis A and extend perpendicular to the axis A such that the cover 56D extends past the battery packs 14 and the battery receiving portions 44D to cover and protect the battery packs 14 and the battery receiving portions 44D from fluid ingress and exposure to the environment.

The housing 18D may further include a carry handle 60D. The carry handle 60D may be located on one of the two ends 35D, 36D. In the illustrated embodiment, the carry handle 60D is disposed on first end 35D of the housing 18D.

The power assembly 22D is located on the first end 35D of the charger 10D. The power assembly 22D includes a plug attached to a power cord 64D and a cord management system 72D. The power cord 64D may be adapted to receive a power supply from a power source (e.g., receive 110V AC from mains electricity) in order to supply power to the charger 10D. The cord management system 72D may be a pocket disposed the first end 35D of the charger 10D that is configured to store the power cord 64D.

The lock assembly 26D is configured to protect the entire charger 10D from theft and protect the individual battery packs 14 from being removed from the charger 10D. The lock assembly 26D includes a cable 76D (e.g., a tether), a padlock latch 80D, and a protrusion 90D.

The cable 76D includes a looped distal end and a proximal end that is secured to the charger 10D via a reel 88D. The reel 88D also allows the cable to be easily retracted from the charger 10D. The cable 76D is configured to be wrapped around a stable structure to secure the charger 10D to the structure.

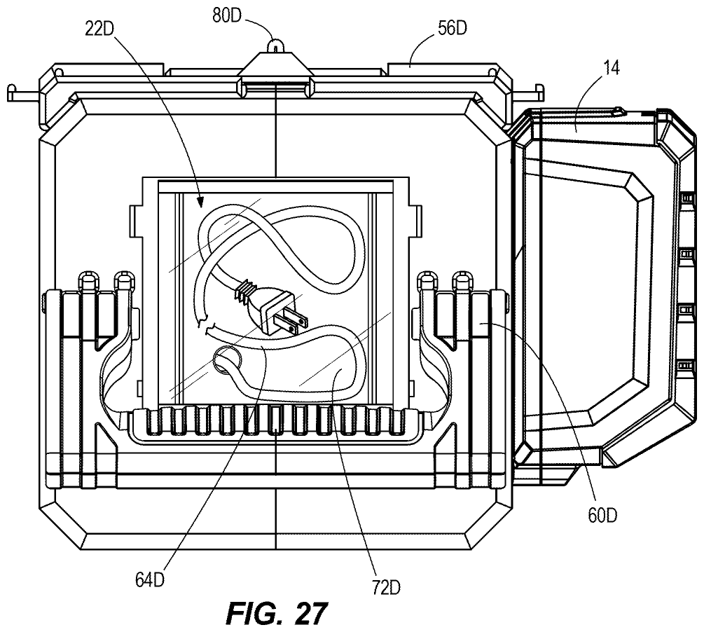

With particular reference to FIGS. 26 and 27, the padlock latch 80D is disposed on the first end 35D of the housing 18D. The padlock latch 80D is configured to receive a padlock. The cover 56D includes a slot that aligns and engages with the padlock latch 80D such that that padlock latch 80D extends past of the cover 56D when the cover 56D is in the closed position. When the padlock is received in the padlock latch 80D, the padlock can secure the cover 56D in the closed position.

The protrusion 90D is disposed adjacent to the padlock latch 80D on the first end 35D. The protrusion 90D is sized such that the distal end of the cable can be received about the protrusion 90D. The protrusion 90D and the distal end of the cable are covered by the cover 56D when the cover 56D is in the closed position. When the cover 56D is in the closed position, the distal end of the cable is secured to the charger 10D by the protrusion 90D and the cover 56D such that the cable is trapped onto the protrusion 90D.

The charger 10D may also include at least one LED indicator 108D. The LED indicator 108D is disposed on the housing 18D and is configured show the status of the battery packs 14. The cover 56D may include a plurality of viewing holes that allow the LED indicator 108D to be visible when the cover 56D is in the closed position.

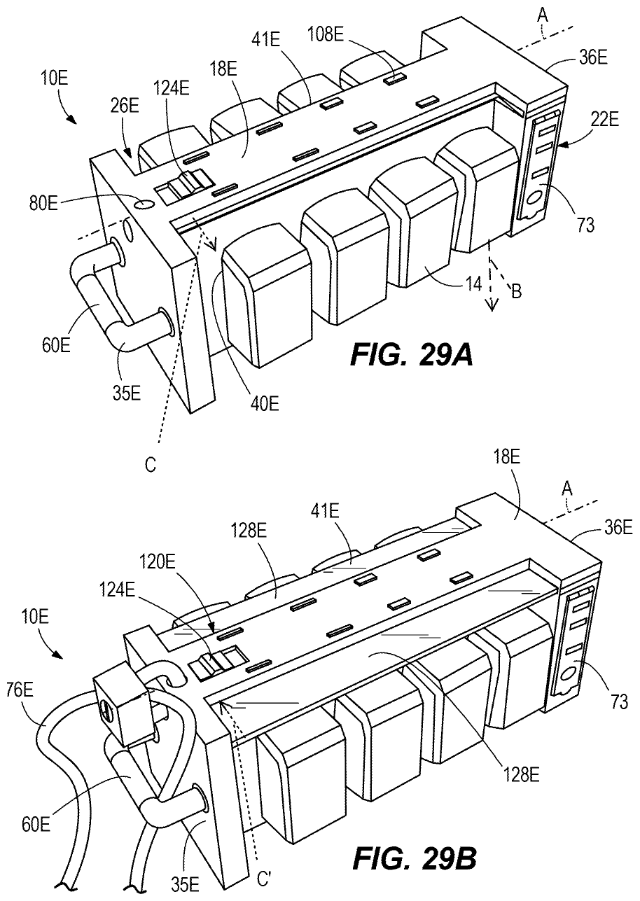

Turning to FIGS. 29A-29B, still another embodiment of a portable charger 10E is shown. Many features of the charger 10E are similar to those discussed above with regard to the charger 10. As such, many of these features will not be discussed again below.

The charger 10E includes a housing 18E that has a generally rectangular shape and defines a first end 35E, a second end 36E, a first side 40E, and a second side 41E. The first side 40E and second side 41E extend along an axis A. The charger 10E includes a plurality of battery receiving portions 44E disposed along the first side 40E and the second side 41E such that the battery pack 14 is insertable in an insertion direction B. More specifically, the insertion direction B may be in the downward direction toward the work surface such that the insertion direction B is transverse to the axis A. The housing 18E includes a carry handle 60E disposed on one of the ends 35E, 36E of the housing 18E.

The charger 10E may include a power assembly 22E on the first or second side 40E, 41E adjacent the second end 36E of the charger 10E. The power assembly 22E may include a plug attached to a power cord, an AC outlet port, and a USB outlet port. The power assembly may include a panel 73 that protects the power assembly 22E from ingress (e.g., water or dust).

The charger 10E includes a lock assembly 26E having a cable 76E, a battery pack locking mechanism 120E, an actuator 124E, and a padlock latch 80E. The cable 76E includes a distal end and a proximal end that is secured to the charger 10E. The cable 76E is configured to be wrapped around a stable structure to secure the charger 10E to the stable structure.

The battery pack locking mechanism 120E is configured to secure the battery packs 14 to the charger 10E. The battery pack locking mechanism 120E includes a set of tabs 128E. A first tab is disposed along the first side 40E of the charger 10E, and a second tab is disposed along the second side 41E of the charger 10E. The set of tabs 128E are elongated tabs such that the tabs 128E extend along the axis A. The first tab has a first length that extends along the first side 40E and a first width that extends perpendicular to the first length. The second tab has a second length that extends along the second side 41E and a second width that extends perpendicular to the second length.

The tabs 128E are moveable between an unlocked position (e.g., a retracted position, FIG. 29A) and a locked position (e.g., an extended position, FIG. 29B). The first tab is moveable in a first extension direction that is parallel to the first width. The second tab is moveable in a second extension direction that is parallel to the second width.

In the unlocked position, the tabs 128E are at least partially recessed or disposed in the housing 18E. More specifically, the majority of each of the tabs 128E is recessed in the housing 18E in the unlocked position. In the locked position, the tabs 128E are extended from the housing 18E and cover at least a portion of the battery pack disposed in the battery receiving portion 44 such that the battery pack 14 cannot be removed. In the locked position, the tabs 128E also provide the battery packs 14 with ingress protection.

The plurality of tabs 128E move along an axis that is transverse to the axis A. More specifically, the plurality of tabs 128E move along an axis that is perpendicular to the axis A. The plurality of tabs 128E move in an extension direction C (e.g., the first extension direction and the second extension direction) to move from the unlocked position to the locked position. In the illustrated embodiment, the extension direction C is in a direction away from the housing 18E. The plurality of tabs 128E move in a retraction direction C′ (e.g., a first retraction direction and a second retraction direction) to move from the locked position to the unlocked position. In the illustrated embodiment, the retraction direction C′ is in a direction toward the housing 18E. The retraction direction C′ is opposite to the extension direction C. The extension and retraction directions C, C′ may be transverse to the insertion direction B. More specifically, the extension and retraction directions C, C′ may be perpendicular to the insertion direction.

The actuator 124E is moveable between a first position (FIG. 29A) and a second position (FIG. 29B). The actuator 124E may move along an actuator axis that is transverse to the extension and retraction directions C, C′. More specifically, the actuator 124E may be moveable along an actuator axis that is perpendicular to the extension and retraction directions C, C′ but is parallel to the axis A.

The actuator 124E is configured to move the tabs 128E between the unlocked position and the locked position. The actuator 124E includes a through hole that is configured to receive a padlock. In the second position, the through hole of the actuator 124E is aligned with the padlock latch 80E such that a padlock can be inserted into the through hole and the padlock latch 80E to lock the actuator 124E in the second position. In the illustrated embodiment, the padlock latch 80E is recessed in the housing 18E.

The charger 10E may also include at least one LED indicator 108E. The LED indicator 108E is disposed on the housing 18E. The LED indicator 108E is operable to show the condition of the charger 10E and the battery packs 14. The LED indicator 108E may be operable to show if the battery pack locking mechanism 120E of the charger 10E is in the locked state or if the charger 10E is in the unlocked state.

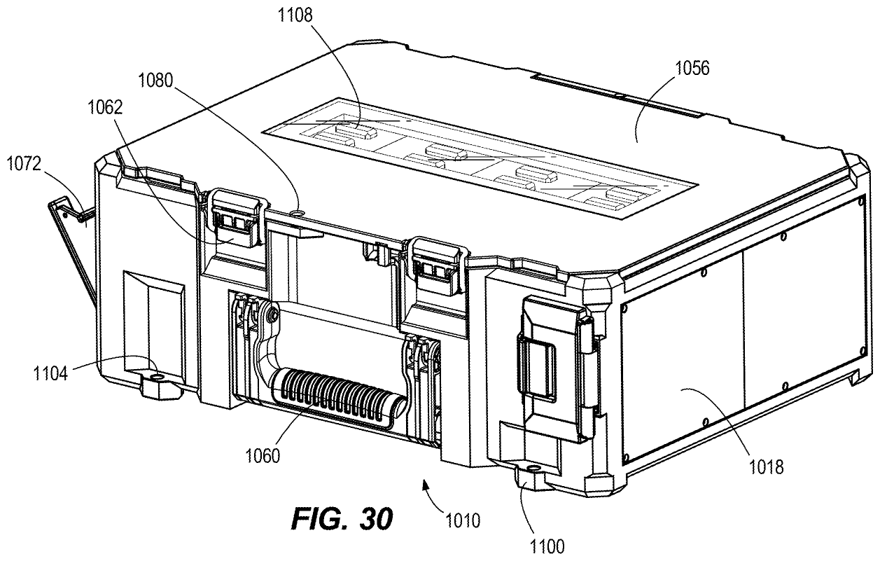

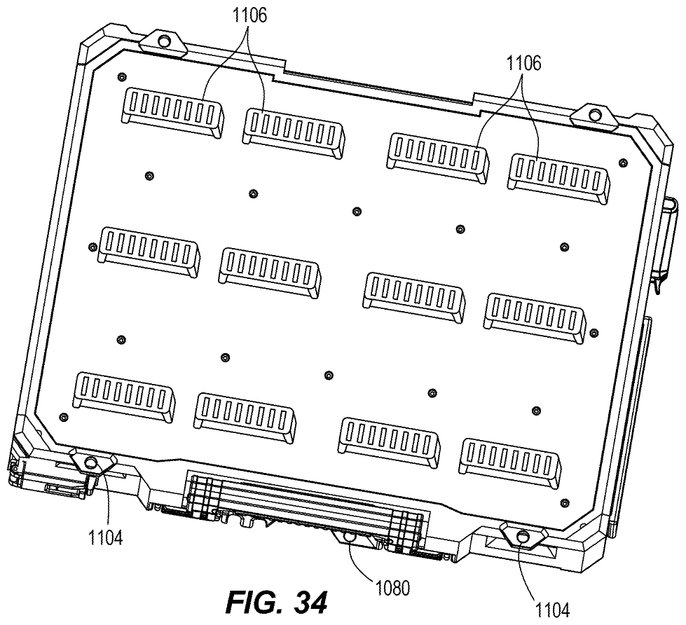

With reference to FIGS. 30-35B, yet another embodiment of a portable charger 1010 for use with multiple battery packs is shown. The charger 1010 generally has a housing 1018 that defines a rectangular shape, a power assembly 1022, and a lock assembly 1026.

The housing 1018 defines a first end 1035, a second end 1036 opposite the first end 1035, a first side 1040, and a second side 1041 opposite the first side 1040. The housing 1018 may define an internal storage compartment 1038 (e.g., a cavity) disposed between the first end 1035 and the second end 1036. In the illustrated embodiment, the charger 1010 has a briefcase shaped housing 1018.

The internal storage compartment 1038 includes a plurality of battery receiving portions 1044 configured to physically secure the battery packs 14 to the charger 1010 and electrically connect the battery packs 14 to the charger 1010. The battery receiving portions 1044 are similar to the battery receiving portions 44 of the charger 10. In some embodiments, the charger 1010 is configured to charge multiple battery packs 14 simultaneously. In the illustrated embodiment, the charger 1010 can charge four battery packs 14 simultaneously. In the illustrated embodiment, the charger 10 includes eight battery receiving portions 44.

The battery receiving portions 44 include a plurality of a first type of charging bays 1048 (e.g., a first subset) and a plurality of a second type of charging bays 1052 (e.g., a second subset). The first type of charging bay 1048 may be configured to only receive a first type of battery pack. The second type of charging bay 1052 may be configured to receive the first type of battery pack, a second type of battery pack, or the first type and second type of battery pack.

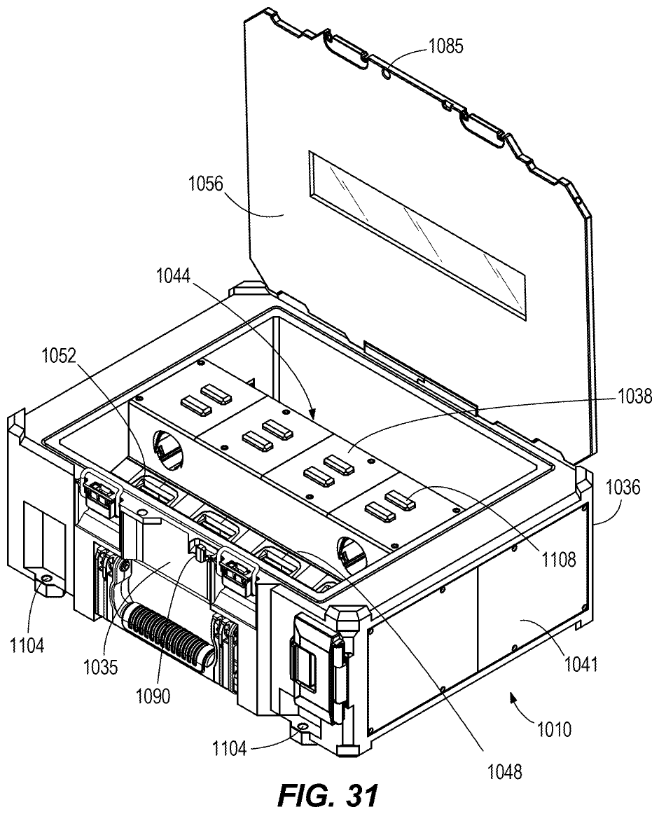

The charger 1010 may additionally include a cover 1056 pivotably coupled to the upper surface of the second end 1036. More specifically, the cover 1056 is pivotable between an opened position where the cover 1056 is pivoted away from the upper surface of the first end 1035 (FIG. 31), to a closed position. In the closed position, the cover 1056 and the housing 1018 enclose the internal storage compartment 1038. When the cover 1056 is in the closed position, the cover 1056 protects battery packs 14 positioned within the internal storage compartment 1038 from ingress (e.g., water and dust). The cover 1056 additionally includes at least one latche 1062 (e.g., a toggle latch) to secure the cover 1056 to the first end 1035 of the charger 1010 in the closed position. In the illustrated embodiment, the cover 1056 includes a window or a clear section. At least a portion of the internal storage compartment 1038 may be visible through the clear section when the cover 1056 is in the closed position.

The housing 1018 may include a carry handle 1060. In the illustrated embodiment, the carry handle 1060 is a pivotable handle that is disposed on the first end 1035 of the housing 1018.

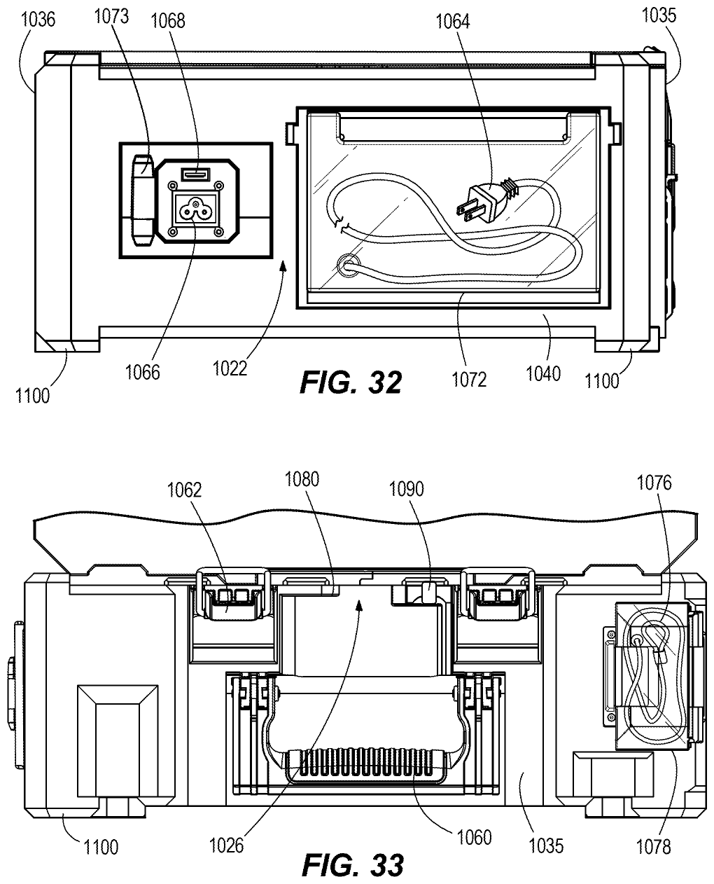

With reference to FIG. 32, the power assembly 1022 may be disposed on the first side or second side 1040, 1041 of the charger 1010. In the illustrated embodiment, the power assembly 1022 is disposed on the first side 1040 of the charger 1010. The power assembly 1022 includes a plug attached to a power cord 1064 and includes at least one outlet port 1068. The power cord 1064 may be adapted to receive a power supply from a power source (e.g., receive 110V AC from mains electricity) in order to supply power to the charger 1010. The supplied power may be used to directly charge the connected battery packs 14. The supplied power may also be used to charge an internal battery (not shown). The internal battery allows the charger 1010 to be used (i.e., charge the battery packs 14) in a remote location when there are no power sources.

The charger 1010 may include a cord management system 1072 that is configured to store and organize the power cord 1064 when the power cord 1064 is not in use. The cord management system 1072 may be a pocket disposed the first side 1040 of the charger 1010. The cord management system 1072 may include a cover that protects the power cord 1064 from dust and water. The inside of the cord management system 1072 may include a set of arms or extensions around which the cord of the power cord 1064 can be wrapped.

The outlet port 1068 allows the user to plug in other devices, such as a cell phone or a tablet to be charged by the charger 1010. The outlet port 1068 may be a USB port. The outlet port 1068 may be covered with a panel 1073 to protect the outlet port 1068 from water damage. In the illustrated embodiment, the charger 1010 includes two outlet ports 1068 that are USB ports. The charger 1010 may also include an outlet port that is a 110-Volt AC port 1066.

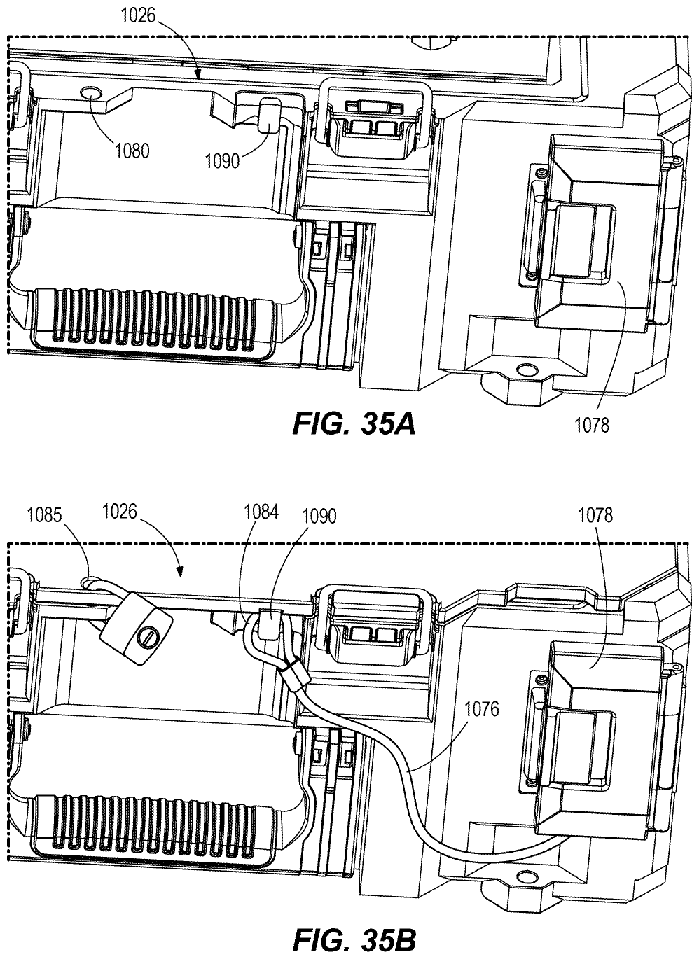

With reference to FIGS. 33, 35A, and 35B, the lock assembly 1026 is disposed on the first end 1035 of the charger 1010. The lock assembly 1026 includes a cable 1076, a through hole 1080 disposed in the housing, and a protrusion 1090 (e.g., a hook). The cable 1076 includes a distal end 1084 and a proximal end that is secured to the charger 1010. The cable 1076 may be stored via a cable management system 1078. The cable management system 1078 may be a pocket disposed the first end 1035 of the charger 1010 and be sized to receive the cable 1076. The cable 1076 is retractably coupled to the housing 1018.

The through hole 1080 may be disposed on the first end 1035 of the housing 1018. The through hole 1080 is configured to receive a padlock. The cover 1056 includes a cover through hole 1085 that is configured to align with the through hole 1080 when the cover 1056 is in the closed position such that the padlock passes through the cover through hole 1085 and the through hole 1080. When the padlock is received in the through hole 80 and the cover through hole 1085, the padlock can secure the cover 1056 in the closed position.

The protrusion 1090 is disposed adjacent to the padlock latch 1080 on the first end 1035. The protrusion 1090 is sized such that the distal end 1084 of the cable 1076 can be wrapped around the protrusion 1090. The protrusion 1090 and the distal end 84 of the cable 1076 are covered by the cover 1056 when the cover 1056 is in the closed position. When the cover 1056 is in the closed position, the protrusion 1090 and the cover 1056 form a closed loop. The distal end 1084 of the cable 1076 is configured to be removably secured to the protrusion 1090. When the cover 1090 is in the closed position, the cable 1076 is trapped onto the protrusion 1090 such that the cable 1076 cannot be unwrapped or removed from the protrusion 1090.

When the lock assembly 1026 is in use, the cable 1076 is wrapped around a secure, stable structure (e.g., a table, a column) to secure the charger 1010 to the structure. Once the cable 1076 is wrapped around the object, the distal end 1084 of the cable 1076 is secured (e.g., snapped) to the protrusion 1090 on the charger 1010. To further secure the cable 1076 to the charger 1010, the cover 1056 is moved to the closed position such that the cover 1056 covers the protrusion 1090 and the distal end 1084 of the cable 1076 (FIG. 35B). The cover 1056 prevents the distal end 1084 from disengaging with the protrusion 1090. The padlock can be inserted into the latch 1080 and the cover through hole 1085 to lock the cover 1056 in the closed position. When the cover 1056 is locked in the closed position the battery packs 14 cannot be removed from the charger 1010. If the charger 1010 is tethered to an object, the padlock ensures that the charger 1010 cannot be moved from the object by securing the distal end 1084 of the cable 1076 to the charger 1010.

The charger 1010 may include a plurality of mounts configured to mount the charger 1010 to a work surface. The charger 1010 may include mounting holes 1104 disposed on the feet 1100 of the charger 1010. The mounting holes 1104 are sized to fit a fastener (e.g., a bolt). The charger 1010 may also include a plurality of mounting cleats 1106 (e.g., PACKOUT Cleats) disposed on the backside of the charger 1010 (e.g., opposite the cover 1056).

The charger 1010 may also include at least one LED indicator 1108. The LED indicator 1108 is disposed on the housing 1018. The LED indicator 1108 is operable to show the condition of the charger 1010 and the battery packs 14. The charger 1010 has a plurality of LED indicators 1108, and more specifically, each battery receiving portion 1044 has its own LED indicator 1108 that is operable to show that charge status of the battery pack 14. The LED indicator 1108 may be visible through the window of the cover 1056.

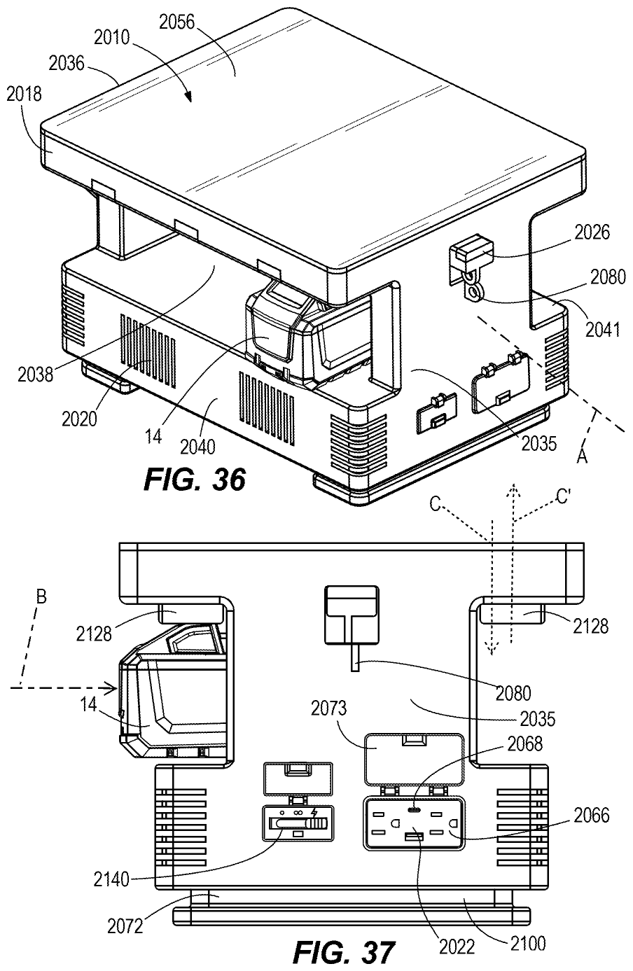

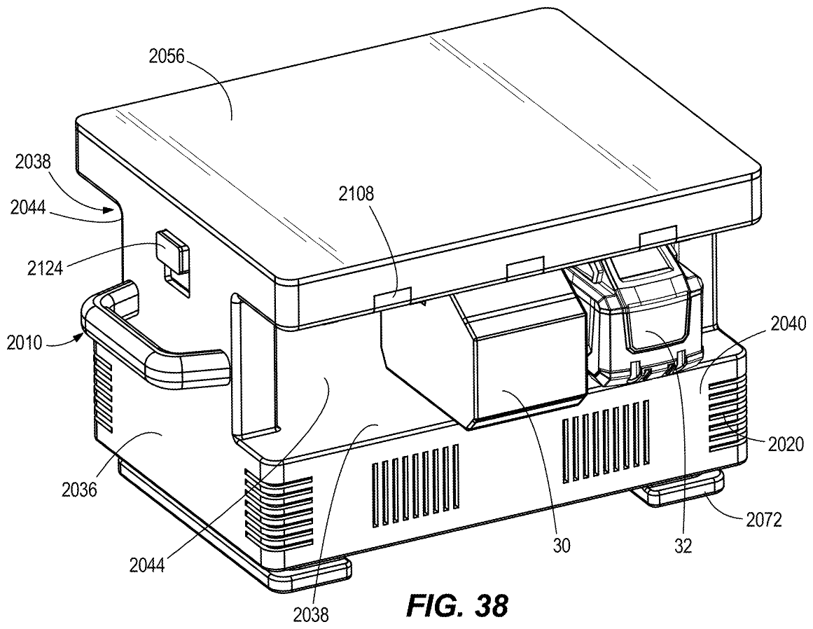

With reference to FIGS. 36-39B, yet another embodiment of a portable charger 2010 for use with multiple battery packs 14 is shown. The charger 2010 generally has a housing 2018 that defines a rectangular shape, a power assembly 2022, and a lock assembly 2026.

The housing 2018 defines a first end 2035, a second end 2036 opposite the first end 2035, a first side 2040, and a second side 2041 opposite the first side 2040. The first side 2040 and the side 2041 extend along an axis A. The housing 2018 may define a storage compartment 2038 disposed along the first side 2040 and along the second side 2041. The housing 2018 also includes a plurality of vents 2020 disposed around the housing that prevent the charger 2010 from overheating.

The storage compartment 2038 is between the two ends 2035, 2036. The storage compartment 2038 includes a plurality of battery receiving portions 2044 configured to physically secure the battery packs 14 to the charger 2010 and electrically connect the battery packs 14 to the charger 2010. In the illustrated embodiment, the battery receiving portions 2044 are disposed on a top surface of the storage compartment 2038, such that when the battery packs 14 are connected to the battery receiving portions 2044, the battery packs 14 are suspended. The battery receiving portions 2044 are configured to receive a first type of battery pack 30 and a second type of battery pack 32. The battery packs 14 are inserted into the battery receiving portions 2044 in an insertion direction B. The insertion direction B is transverse to the axis A. More specifically, the insertion direction B is perpendicular to the axis A. In the illustrated embodiment, the charger 10 includes six battery receiving portions 44.

The charger 2010 may also include a cover 2056. The cover 2056 may be fixed to the top of the charger 2010. The cover 2056 may extend slightly past the charger 2010 to at least partially protect the battery packs 14 form ingress.

The charger 2010 may include feet 2100 disposed on the base (e.g., the end opposite the cover 2056 and adjacent the work surface) of the charger 2010. The feet 2100 lift the charger 2010 from the work surface to protect the charger 2010 from hazards on the work surface (e.g., water).

The power assembly 2022 may be disposed on the first end 2035 of the housing 2018. The power assembly 2022 includes a plug attached to a power cord 2064 and includes at least one outlet port 2068. The power cord 2064 may be adapted to receive a power supply from a power source (e.g., receive 110V AC from mains electricity) in order to supply power to the charger 2010. The supplied power may be used to directly charge the connected battery packs 14. The supplied power may also be used to charge an internal battery (not shown). The internal battery allows the charger 2010 to be used (i.e., charge the battery packs 14) in a remote location when there are no power sources.

The charger 2010 may include a cord management system 2072 that is configured to store and organize the power cord 2064 when the power cord 2064 is not in use. The cord management system 1072 may be a cord wrap that is disposed on the base or feet 2100 of the charger 2010. More specifically, the feet 2100 of the charger 2010 may include recessed edges that are sized to receive the power cord 2064.

The outlet port 2068 allows the user to plug in other devices, such as a cell phone or a tablet to be charged by the charger 2010. The outlet port 2068 may be a USB port. The outlet port 2068 may be covered with a panel 2073 to protect the outlet port 2068 from water damage. In the illustrated embodiment, the charger 1010 includes two outlet ports 2068 that are USB ports. The charger 2010 may also include an outlet port that is a 110-Volt AC port 2066.

The lock assembly 2026 may have a battery pack locking mechanism 2120, an actuator 2124, and a padlock latch 2080. The battery pack locking mechanism 2120 is configured to secure the battery packs 14 to the charger 2010. The battery pack locking mechanism 2120 includes a plurality of tabs 2128 disposed on the battery receiving portions 2044. More specifically, each battery receiving portion 2044 includes a tab 2128 on either side of the battery receiving portion 2044.

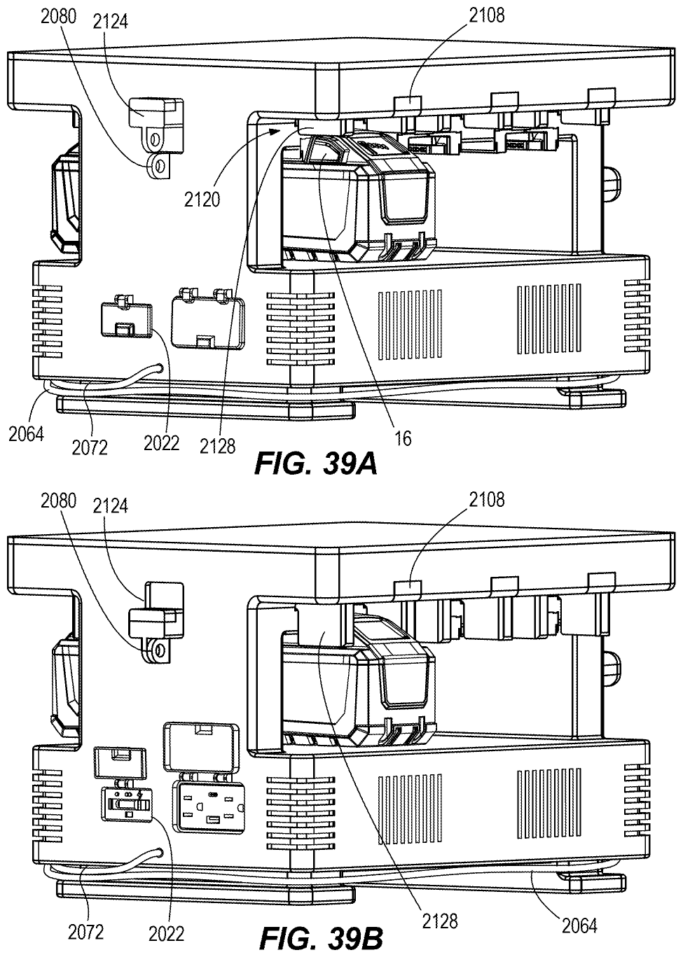

The tabs 2128 are moveable between an unlocked position (e.g., a retracted position, FIG. 39A) and a locked position (e.g., an extended position, FIG. 39B). In unlocked position, the tabs 2128 are spaced from the battery packs 14 such that the battery packs 14 can be removed from the charger 2010 without interference. In the illustrated embodiment, the tabs 2128 are at least partially disposed in the housing 2018 when the 2128 are in the unlocked position. More specifically, the majority of each of the tabs 2128 is disposed in the housing 2018 in the unlocked position. In the locked position, the tabs 2128 are extended from the housing 2018 (e.g., extended downward toward the base of the charger 2010) and cover at least a portion of the battery pack in the receiving portion 2044. More specifically, the tabs 2128 block the grip portion 16 of the battery pack 14 such that the battery pack 14 cannot be removed.

The tabs 2128 move along an axis that is transverse to the axis A. More specifically, the tabs 2128 move along an axis that is perpendicular to the axis A. The plurality tabs 2128 move in an extension direction C to move from the unlocked position to the locked position. In the illustrated embodiment, the extension direction C is in the downward direction toward the base of the charger 2010 and toward the work surface. The tabs 128 move in a retraction direction C′ to move from the locked position to the unlocked position. In the illustrated embodiment, the retraction direction C′ is in the upward direction away from the work surface. The extension and retraction directions C, C′ may be transverse to the insertion direction B. More specifically, the extension and retraction directions C, C′ may be perpendicular to the insertion direction.

The actuator 2124 is moveable between a first position (FIG. 39A) and a second position (FIG. 39B). The actuator 2124 may move along an actuator axis that is generally parallel to the extension and retraction directions C, C′. The actuator axis may be transverse to the axis A and transverse to the insertion direction B.

The actuator 2124 moves the tabs 2128 between the unlocked position and the locked position. The actuator 2124 may be configured to move the tabs 2128 simultaneously. The actuator 2124 includes a through hole that is configured to receive a padlock. In the second position, the through hole of the actuator 2124 is aligned with the padlock latch 2080 such that a padlock can be inserted into the through hole and the padlock latch 2080 to lock the actuator 2124 in the second position. In the illustrated embodiment, the actuator 2124 is a slide mechanism that slides between the first and second position. In the illustrated embodiment, the charger 2010 includes a first actuator disposed on the first end 2035 and a second actuator disposed on the second end 2036 of the charger 2010. The first actuator and the second actuator are configured to move simultaneously.

The charger 2010 may also include at least one LED indicator 2108. The LED indicator 2108 is disposed on the housing 2018. The LED indicator 2108 is operable to show the condition of the charger 2010 and the battery packs 14. The LED indicator 2108 may be operable to show if the battery pack locking mechanism 2120 of the charger 2010 is in the locked position or if the charger 2010 is in the unlocked position.

The charger 2010 may also have a charge-rate switch 2140. The charge-rate switch 2140 may be disposed on the first end 2035 of the charger 2010. The charge-rate switch 2140 may be operable to control the rate at which the battery packs 14 are charging. The charge-rate switch 2140 may switch the charger 2010 between a low-power mode, a medium-power mode, and a high-power mode. In the low-power mode, the charger 2010 may provide less voltage to the battery packs 14 to slowly charge battery packs and save power, while in the high-power mode the charger 2010 may provide a high voltage to the battery packs 14 to quickly charge the battery packs.

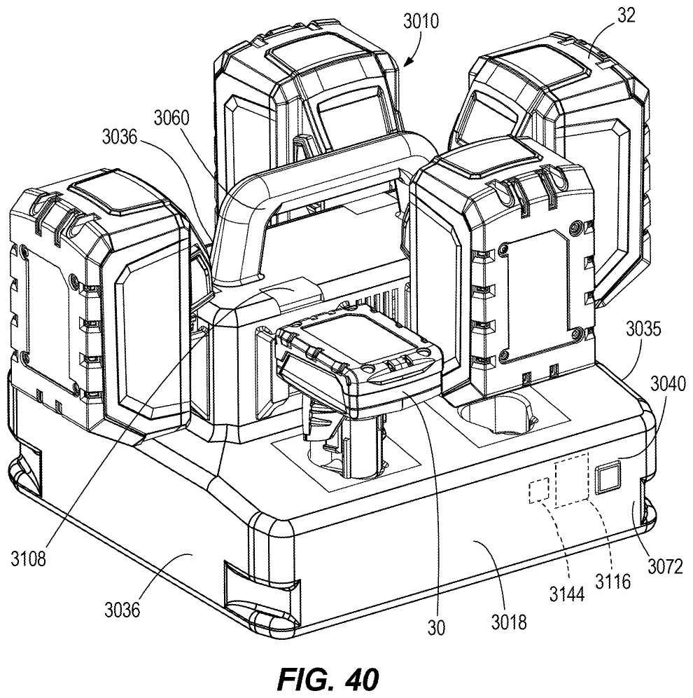

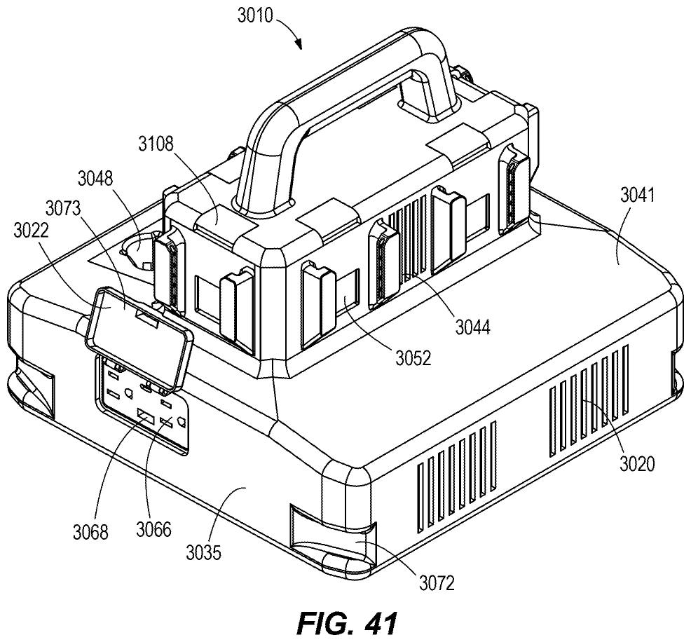

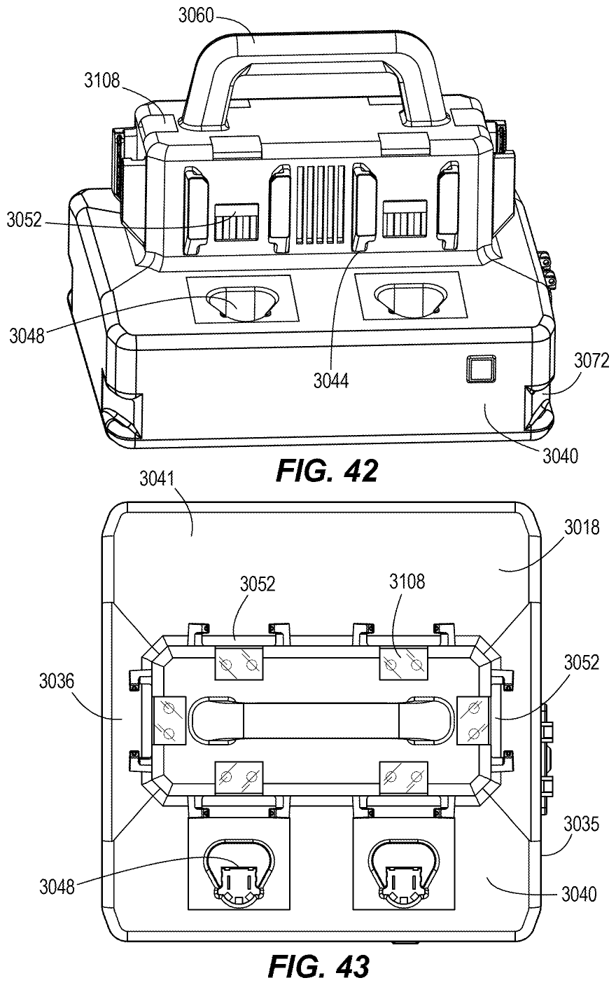

With reference to FIGS. 40-44D, an embodiment of a charger 3010 for use with multiple battery packs 14 is shown. The charger 3010 includes a housing 3018, a plurality of battery receiving portions 3044, and a power assembly 3022. The housing 3018 defines a first end 3035, a second end 3036, a first side 3040, and a second side 3041. The housing 3018 defines a basket shape with a carry handle 3060 disposed in the middle of the charger 3010. The housing 3018 may further define a plurality of vents 3020 that are configured to cool the charger 3010 and/or the battery packs 14.

The battery receiving portions 3044 may be disposed along the perimeter of the charger (e.g., along the first end 3035, along the second 3036, along the first side 3040, and along the second side 3041). The charger 3010 includes a plurality of the first type of charging bay 3048 configured to charge a first type of battery pack 30 and a plurality of second type of charging bay 3052 configured to charge the first type of battery pack 30 and/or the second type of battery pack 32. The second type of charging bays 3052 may be disposed on the first side 3040. The battery receiving portions 3044 are configured such that the battery packs 14 are mostly or fully exposed to the environment. In the illustrated embodiment, the charger 3010 includes two of the second type of charging bay 3052 and four of the first type of charging bay 3048.

The power assembly 3022 may be disposed on the first end 3035 of the housing 3018. The power assembly 3022 may include a plug attached to a power cord and include at least one outlet port 3068. The power cord may be adapted to receive a power supply from a power source (e.g., receive 110V AC from mains electricity) in order to supply power to the charger 3010. The supplied power may be used to directly charge the connected battery packs 14. The supplied power may also be used to charge an internal battery (not shown). The internal battery allows the charger 3010 to be used (i.e., charge the battery packs 14) in a remote location when there are no power sources.

The charger 3010 may include a cord management system 3072 that is configured to store and organize the power cord when the power cord is not in use. The cord management system 3072 may be a cord wrap that is disposed on the base of the charger 3010. More specifically, the base (e.g., the surface opposite the handle 3060 and adjacent the work surface) includes recessed edges that are sized to receive the cord.

The outlet port 3068 allows the user to plug in other devices, such as a cell phone or a tablet to be charged by the charger 3010. The outlet port 3068 may be a USB port. The outlet port 3068 may be covered with a panel 3073 to protect the outlet port 3068 from water damage. In the illustrated embodiment, the charger 1010 includes two outlet ports 3068 that are USB ports. The charger 3010 may also include an outlet port that is a 110-Volt AC port 3066.

The charger 3010 may also include at least one LED indicator 3108. The LED indicator 3108 is disposed on the housing 3018. The LED indicator 3108 is operable to show the condition of the charger 3010 and the battery packs 14. The LED indicator 3108 may also show if the charger 3010 is connected to a remote device.

The charger 3010 may have a controller 3116 disposed in the housing 3018. The controller 3116 is operable to send signals to a wireless communicator 3144 (e.g., a wireless communication device) that is operable to transmit signals to the remote device (e.g., a cell phone, a tablet, a laptop). The wireless communicator 3144 may be operable to provide the remote device with real-time information regarding the charger 3010 and the operation of the charger 3010. The remote device may be able to control the charger 3010 via the wireless communicator 3144.

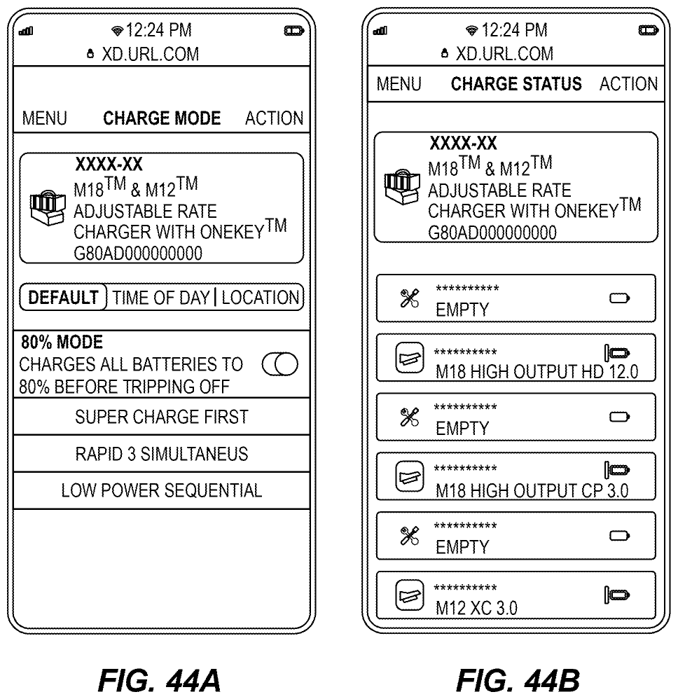

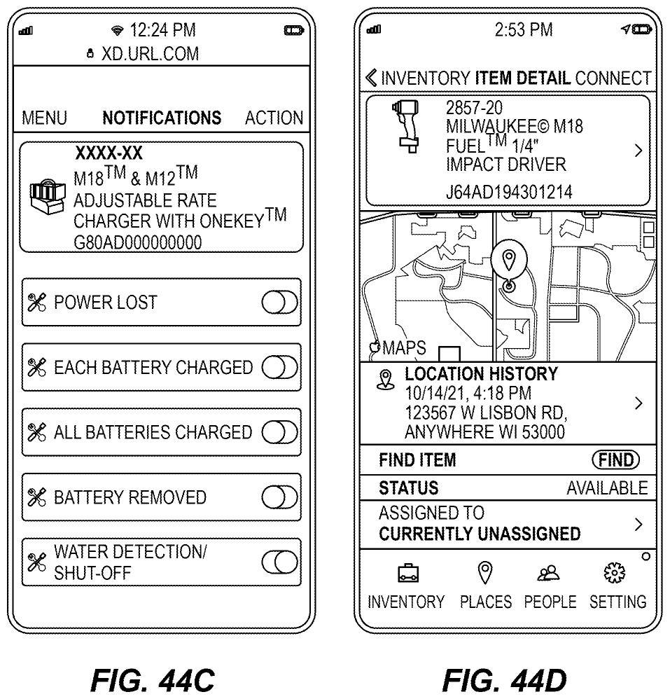

With reference to FIG. 44A, the wireless communicator 3144 may allow the user to switch or view the charging mode (e.g., the charging speed) of the charger 3010 or the charging mode of at least one of charging bays 3044 with the remote device. More specifically, the user may switch the charger 3010 between a super-charge mode, a simultaneous-charge mode, and a low-power charge mode. In the simultaneous-charge mode, the charger 3010 may be configured to rapidly and simultaneously charge a plurality of battery packs. More specifically, the charger 3010 may be able to charge up-to three battery packs simultaneously. To save power, the charger 3010 may be operable to charge the battery packs 14 sequentially.

With reference to FIG. 44B, the wireless communicator 3144 may allow the user to track the charge status of the battery packs 14 attached to the charger 3010 via the remote device. For example, the user may be able to see if there are empty battery pack receiving portions 3044, if a battery pack is fully charged, or if the battery pack is slowly charging.

With reference to FIG. 44C, the wireless communicator 3144 may allow the user to track the health of the charger 3010 or the health of the battery packs disposed in one of charging bays 3044. For example, the wireless communicator 3144 may notify the remote device about the power level of the charger 3010, the charge status of the battery packs 14 disposed in the charging bays 3044, if the charger 3010 loses power, if each battery pack 14 is charged, if a battery pack 14 is removed from the charger 3010, and if the charger 3010 detects water. This allows the user to know in real time if there is an issue (e.g., low battery or water damage) with the charger 3010.

With reference to FIG. 44D, the wireless communicator 3144 may provide the remote device with the real time location of the charger 3010.

Various features of the disclosure are set forth in the following claims.

1-16. (canceled)

17. A charger comprising:
a housing having a first end and a second end opposite the first end;
a plurality of charging bays disposed between the first end and the second end, each of the plurality of charging bays configured to removably receive a battery pack in an insertion direction;
a plurality of tabs moveably coupled to the housing, each of the plurality of tabs moveable between a locked position and an unlocked position, wherein, in the locked position, each tab is configured to cover at least a portion of a respective battery pack received in a respective charging bay of the plurality of charging bays;
an actuator configured to move the plurality of tabs between the locked position and the unlocked position; and
a staple coupled to the housing, the staple having a through hole configured to receive a lock to lock the plurality of tabs in the locked position.

18. The charger of claim 17, wherein, in the locked position, at least one of the plurality of tabs covers a user engagement portion of a respective battery pack received in a respective one of the plurality of charging bays.

19. The charger of claim 18, wherein each of the plurality of charging bays has a tab of the plurality of tabs disposed on a side of a respective charging bay.

20. The charger of claim 18, wherein each of the plurality of tabs is L-shaped.

21. The charger of claim 18, wherein each of the plurality of tabs is moveable in a first direction, and wherein the first direction is transverse to the insertion direction.

22. The charger of claim 21, wherein the first direction is perpendicular to the insertion direction.

23. The charger of claim 22, wherein the actuator is moveable along an actuator axis, wherein the actuator axis is transverse to the insertion direction.

24. The charger of claim 23, wherein the actuator axis is coincident with a plane, the plane being perpendicular to another plane, the insertion direction being coincident with the other plane.

25. The charger of claim 18, wherein
the housing includes a first side and a second side opposite the first side,
the plurality of tabs includes a first tab and a second tab,
the first tab has
a first length that extends along the first side, and
a first width that extends perpendicular to the first length, and
the second tab has
a second length that extends along the second side, and
a second width that extends perpendicular to the second length.

26-28. (canceled)

29. The charger of claim 18, wherein the actuator is configured to move the plurality of tabs simultaneously.

30-31. (canceled)

32. The charger of claim 18, wherein a first subset of the plurality of charging bays is configured to receive a first type of battery pack, and wherein a second subset of the plurality of charging bays is configured to receive a second type of battery pack.

33-38. (canceled)

39. A charger comprising:
a plurality of charging bays, each of the plurality of charging bays configured to removably receive a battery pack in an insertion direction;
a plurality of tabs, each of the plurality of tabs moveable relative a respective charging bay of the plurality of charging bays between a locked position and an unlocked position, each of the plurality of tabs in the locked position configured to extend into a respective charging bay of the plurality of charging bays;
an actuator movable relative the plurality of charging bays such that movement of the actuator causes movement of the plurality of tabs between the locked position and the unlocked position; and
a staple coupled to the housing, the staple having a through hole configured to receive a lock to lock the actuator in place.

40. The charger of claim 39, wherein each of the plurality of tabs is disposed on a side of a respective charging bay of the plurality of charging bays.

41. The charger of claim 40, wherein at least one charging bay of the plurality of charging bays has a second tab of the plurality of tabs disposed on a second, opposite side of the respective charging bay.

42. The charger of claim 39, wherein each of the plurality of tabs is L-shaped.

43. The charger of claim 39, wherein each of the plurality of tabs is moveable in a first direction, and wherein the first direction is transverse to the insertion direction.

44. The charger of claim 39, wherein the actuator is configured to move the plurality of tabs simultaneously.

45. The charger of claim 39, wherein a first subset of the plurality of charging bays is configured to receive a first type of battery pack, and wherein a second subset of the plurality of charging bays is configured to receive a second type of battery pack.

46. A charger comprising:
a housing having a first end and a second end opposite the first end, the housing extending along a first axis;
a charging bay disposed between the first end and the second end, the charging bay configured to removably receive a battery pack in an insertion direction;
a tab moveably coupled to the housing and disposed on a side of the charging bay, the tab moveable between a locked position and an unlocked position, the tab configured to move to the locked position and thereby cover at least a portion of the battery pack received in the charging bay;
an actuator assembly including an actuator configured to move the tab between the locked position and the unlocked position; and
a staple coupled to the housing, the staple having a through hole configured to receive a lock to lock the actuator assembly with the tab in the locked position,
wherein the tab is moveable in a direction transverse to the insertion direction.

47. The charger of claim 46, wherein the tab is moveable along an axis parallel to the first axis.
